(19) United States
(12) Patent Application Publication
(10) Pub. No.: US 2026/0151994 A1
(43) Pub. Date: Jun. 4, 2026

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventors: HIROTO KANGO, Tokyo (JP); TAKESHI MURASE, Kanagawa (JP); HIROSHI TAIRA, Tokyo (JP); SAE MOGI, Kanagawa (JP); SHUNNOSUKE KOSEKI, Kanagawa (JP); KAZUO SUZUKI, Kanagawa (JP)

(21) Appl. No.: 19/393,807

(22) Filed: Nov. 19, 2025

(30) Foreign Application Priority Data
Nov. 29, 2024 (JP) 2024-208416

(51) Int. Cl. B41J 2/045; B41J 2/175; B41J 11/00

(52) U.S. Cl. CPC B41J 2/04515; B41J 2/04553; B41J 2/04563; B41J 2/04573; B41J 2/0458; B41J 2/17596; B41J 11/00222

(57) ABSTRACT

A printing apparatus includes: a print head configured to eject a liquid onto a print medium to print an image; a temperature detector provided to the print head and configured to detect a temperature; and a controller configured to perform standby control which causes the print head to stand by for a standby time in a case where the temperature detected by the temperature detector is higher than a standby temperature. The controller determines whether to perform the standby control based on at least one of print information for printing an image onto the print medium with the print head or environmental temperature information on an environmental temperature.

### BACKGROUND

### Field of the Technology

The present disclosure relates to a printing apparatus, a method of controlling a printing apparatus, and a storage medium.

### Description of the Related Art

An inkjet printing apparatus as an example of a printing apparatus prints images on a print medium by ejecting liquids, such as inks, from a print head. Print heads such as a thermal print head and a piezoelectric print head have been known. The thermal print head ejects ink droplets from ejection ports by generating bubbles in the inks through boiling. The manufacturing of the thermal print head involves forming electrothermal conversion elements and electrodes on a substrate and then forming liquid path walls, top plates, and the like that form ejection ports and liquid paths by using semiconductor manufacturing processes. In the thermal print head, a plurality of liquid paths for supplying the inks to the ejection ports and a plurality of printing elements, which are the electrothermal conversion elements, for causing film boiling in the inks inside the liquid paths are densely disposed.

In a print head in which a plurality of printing elements are densely disposed, the printing elements, which are electrothermal conversion elements, are caused to generate heat rapidly. Thus, the more frequently the inks are ejected, the more heat gets accumulated in the print head. As heat gets accumulated in the print head, the temperature of the inks inside the liquid paths communicating with the ejection ports rises, so that small bubbles are generated from the inks, in which gases are dissolved. The small bubbles generated from the inks inside the liquid paths gradually grow as heat gets accumulated in the print head. The bubbles that have grown inside the liquid paths obstruct the supply of the inks from the ink tanks to the ejection ports in the print head, leading to failure to eject sufficient ink droplets from the ejection ports. Also, there are inks containing fine resin particles that solidify after melting with heat. As heat gets accumulated in the print head, inks containing such fine resin particles may get fixedly attached to the inside or outside of the print head, which may lead to failure to eject sufficient ink droplets from the ejection ports in the print head.

Hereinafter, the failure to eject sufficient ink droplets from the ejection ports in a print head in response to application of electric signals corresponding to image data to its printing elements (electrothermal conversion elements) will be referred to as “ejection failure.” A state where the temperature of a print head has risen to such an extent that ejection failure occurs will be referred to as “overheated state.” In a case where a print head falls into an overheated state, ejection failure may occur, which may in turn affect the image quality and/or damage the print head, for example. A method has been known in which a print head's print operation is controlled by detecting the temperature of the print head during the printing and comparing the detected temperature with a predetermined threshold value to prevent the print head from falling into an overheated state.

For example, Japanese Patent Laid-Open No. 2009-12462 (Document 1) discloses a method in which, in a case where the temperature of a print head rises during printing, a standby time for which the print head is caused to stand by before starting a print operation is distributed and set before each of a plurality of print operations. Hereinafter, control employing the method disclosed in Document 1 will be referred to as “temperature rise suppression control.” The temperature rise suppression control is performed using a temperature range lower than a temperature at or above which the print head will be determined to be in an overheated state. In this way, it is possible to avoid a situation where the temperature of the print head does not sufficiently drop within the standby time and the print head in an overheated state starts the next print operation. Note that, in a case where the print head stands by until the temperature of the print head becomes lower than a predetermined threshold value, the density and hue of the region of the image printed after the standby may become different from the density and hue of the region of the image printed before the standby and be visually recognized as density unevenness and hue unevenness in the image. With the temperature rise suppression control, a standby time for the print head is distributed and set. In this way, the print head can avoid falling into an overheated state while preventing the density unevenness and hue unevenness in the image.

Here, there is a possibility of performing the temperature rise suppression control even in a case where the print head is designed not to fall into an overheated state during printing. Thus, an unnecessary standby time may occur and decrease the throughput of the printing apparatus.

### SUMMARY

An object of the present disclosure is to provide a printing apparatus capable of reducing a decrease in its throughput.

A printing apparatus according to an aspect of the present disclosure includes: a print head configured to eject a liquid onto a print medium to print an image; a temperature detector provided to the print head and configured to detect a temperature; and a controller configured to perform standby control which causes the print head to stand by for a standby time in a case where the temperature detected by the temperature detector is higher than a standby temperature. The controller determines whether to perform the standby control based on at least one of print information for printing an image onto the print medium with the print head or environmental temperature information on an environmental temperature.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating a schematic configuration of a printing apparatus;

FIG. 2 is an exploded perspective view of a print head;

FIG. 3 is a cross-sectional view illustrating the inside of the print head;

FIGS. 4A and 4B are schematic views illustrating electric wirings of an ejection module;

FIG. 5 is a schematic view of a circulation path;

FIGS. 6A and 6B are perspective views of a circulation pump;

FIG. 7 is a cross-sectional view of the circulation pump;

FIGS. 8A and 8B are exploded perspective views of the circulation pump;

FIG. 9 is a cross-sectional view illustrating a piezoceramic member and its vicinity inside the circulation pump;

FIG. 10 is a cross-sectional view illustrating an air blow unit and a fixing unit;

FIG. 11 is a block diagram illustrating a control system of the printing apparatus;

FIG. 12 is an explanatory diagram illustrating a printing method by multipass printing;

FIG. 13 is a flowchart illustrating a method of controlling the printing apparatus;

FIG. 14 is a flowchart illustrating an enablement determination process in a first embodiment;

FIG. 15 is a flowchart illustrating a printing process;

FIG. 16 is a flowchart illustrating a modification of the printing process;

FIG. 17 is a flowchart illustrating an enablement determination process in a second embodiment;

FIG. 18 is a flowchart illustrating an enablement determination process in a third embodiment;

FIG. 19 is a flowchart illustrating an enablement determination process in a fourth embodiment;

FIG. 20 is a flowchart illustrating an enablement determination process in a fifth embodiment;

FIG. 21 is a perspective view illustrating a schematic configuration of a printing apparatus according to a sixth embodiment; and

FIG. 22 is a flowchart illustrating an enablement determination process in the sixth embodiment.

### DESCRIPTION OF THE EMBODIMENTS

Preferred embodiments of the present disclosure will be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical components will be described with the same reference sign.

First, a printing apparatus configuration that is common to each embodiment will be described. The printing apparatus may be, for example, a single-function printer having only a printing function. The printing apparatus may be a multi-function printer having a plurality of functions such as a printing function, a faxing function, and a scanning function. The printing apparatus may be a manufacturing apparatus for manufacturing a color filter, an electronic device, an optical device, a microscopic structure, or the like by a predetermined printing method.

In the following description, “printing” is not limited to formation of information with meaning, such as characters or a figure, and encompasses formation of information regardless of whether or not it contains meaning. Moreover, “printing” is not limited by whether what is to be obtained is elicited to be visually perceptible to humans, and represents formation of an image, a design, a pattern, a structure, or the like on a print medium or processing of a medium.

A “print medium” represents not only paper used in general printing apparatuses but also things that can receive inks such as cloth, plastic films, sheet metal, glass, ceramic, resin, wood, and leather. In particular, “non-permeable print medium/low-permeability print medium” refers to a non-absorbent print medium or low-absorbency print medium. Examples of the non-permeable print medium include those that are not produced as print media for aqueous inkjet inks, such as glass, plastic, film, and Yupo. Examples also include those without a surface treatment for inkjet printing (i.e., those without an ink absorption layer formed thereon), such as plastic films and substrates such as paper coated with plastic. Examples of the plastic include polyvinyl chloride, polyethylene terephthalate, polycarbonate, polystyrene, polyurethane, polyethylene, polypropylene, and so on. Specific examples of the low-permeability print medium include print media such as printed book papers to be used in offset printing, etc., such as art paper and coated paper.

As an example of the low-permeability print medium, an actual printing paper whose permeability to aqueous inks is extremely low as compared to papers dedicated for inkjet printing (poorly absorbent print medium) will be described. “Actual printing paper” refers to a formal (genuine) printing paper to be actually used for final printing in offset printing to obtain a product (commodity). There are uncoated paper and coated paper. Uncoated paper is a paper made from pulp and used as is. Coated paper is a paper whose surface is smoothly coated with a white pigment or the like. Between uncoated paper and coated paper, the latter exhibits marked image impairment and drying impairment due to ink overflow in inkjet printing. The coating layer is a layer obtained by applying a blended coating material in which a paper strength enhancer (e.g., starch), a sizing agent, a filler, and so on are blended at several g/m² to 40 g/m². The sizing agent (e.g., synthetic resin) limits the liquid absorption into gaps between pulp fibers to prevent bleeding of inks from water-based pens. The filler (e.g., kaolin) improves opacity, whiteness, smoothness, and so on. The radii of average capillary pores in coated paper are normally distributed around approximately 0.06 μm. Water penetrates coated paper through many capillary pores in the coated paper (capillarity). Here, the inner volume of capillary pores in coated paper is much smaller than the inner volume of capillary pores in papers dedicated for inkjet printing. For this reason, coated paper has low permeability to aqueous inks and exhibits marked image impairment and drying impairment due to ink overflow on the surface of the coated paper.

As an example of the non-permeable print medium, a polyvinyl chloride sheet, which has no permeability to aqueous inks as compared to papers dedicated to inkjet printing, will be described. Polyvinyl chloride sheets are soft sheets manufactured by adding a plasticizer to a polyvinyl chloride resin being a main raw material. Polyvinyl chloride sheets have good printability for gravure printing, screen printing, and the like and emboss ability (ease of forming a recessed and/or raised design by pressing a mold). Since the combination of high printability and emboss ability enables a greater variety of expressions, polyvinyl chloride sheets have been used in many products such as tarpaulin, canvas, and wallpaper. The main material of polyvinyl chloride sheets is a polyvinyl chloride resin. For this reason, polyvinyl chloride sheets do not have permeability to aqueous inks at all and exhibit marked image impairment and drying impairment due to ink overflow on the surface of the polyvinyl chloride sheet.

The definition of “ink” should be interpreted broadly, as with the definition of “printing” mentioned above. “Ink” represents a liquid that can be applied onto a print medium for formation of an image, a design, a pattern, or the like, processing of the print medium, or processing of an ink. Examples of the processing of an ink include solidification or insolubilization of a color material in an ink applied to a print medium.

### First Embodiment

### Configuration of Printing Apparatus

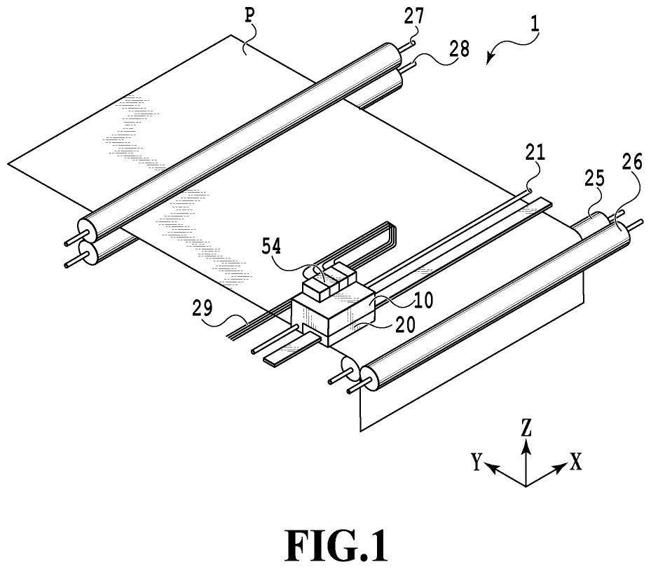

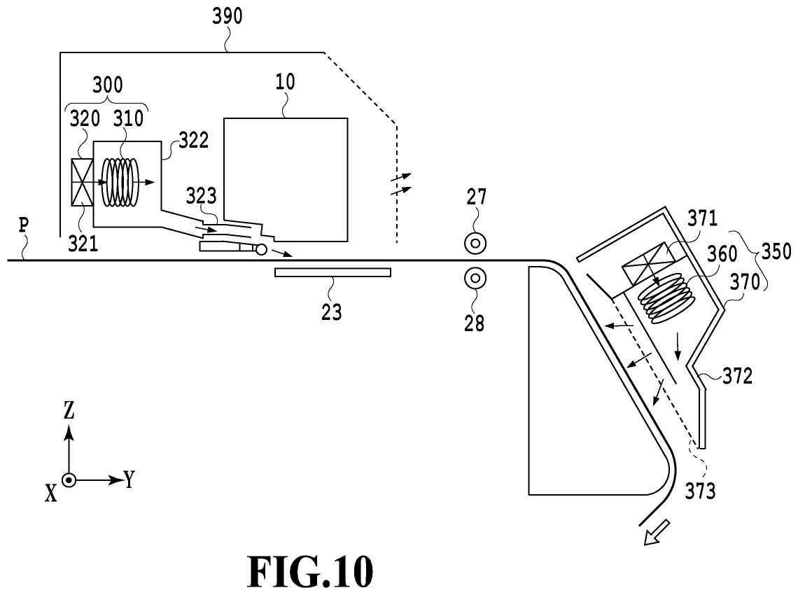

FIG. 1 is a perspective view illustrating a schematic configuration of an inkjet printing apparatus 1 according to the present embodiment (hereinafter referred to as “printing apparatus 1”). As illustrated in FIG. 1, the printing apparatus 1 according to the present embodiment includes a print head 10, a carriage 20, an air blow unit 300 (see FIG. 10 to be described later), and a fixing unit 350 (see FIG. 10 to be described later). The printing apparatus 1 according to the present embodiment is a serial printing apparatus that prints an image on a print medium P by ejecting liquids, such as inks, from the print head 10 while scanning it.

As mentioned earlier, there is a possibility of performing temperature rise suppression control even in a case where the print head is designed not to fall into an overheated state during printing. For example, in a case where the amount of inks to be applied for printing is extremely low, the total amount of energy for ejecting the inks is low. Hence, the print head will not fall into an overheated state during the printing even if heat is accumulated in the print head. In this case, if the threshold temperature value to be compared in the temperature rise suppression control is low, the print head may stand by for a standby time before starting the print operation although the print head does not need to stand by. This unnecessary standby time decreases the throughput of the printing apparatus. In the present embodiment, a configuration capable of reducing the decrease in the throughput of the printing apparatus will be described.

The print head 10 is mounted on the carriage 20. The carriage 20 reciprocally moves in a main scanning direction (X direction) along a guide shaft 21. The print medium P is conveyed in a sub scanning direction (Y direction) crossing (in this example, orthogonally crossing) the main scanning direction by upstream conveyance rollers 25 and 26 and downstream conveyance rollers 27 and 28, which are conveyance devices. Note that, in drawings to be referred to below, the Z direction represents a vertical direction and crosses (in the present embodiment, orthogonally crosses) an X-Y plane defined by the X direction and the Y direction.

The printing apparatus 1 forms a predetermined image on the print medium P by repeating a printing scan involving performing printing by causing the print head 10 mounted on the carriage 20 to eject the inks while moving in the main scanning direction, and a conveyance operation involving conveying the print medium P in the sub scanning direction. Note that the print head 10 in the present embodiment is capable of ejecting four types of inks, namely black (K), cyan (C), magenta (M), and yellow (Y) inks, and printing full-color images with these inks. Here, the inks ejectable from the print head 10 are not limited to the above four types of inks. The present disclosure is also applicable to print heads for ejecting other types of inks. In short, the types and number of inks to be ejected from the print head are not limited. For example, one, two, or three types of inks or even five or more types of inks may be ejected from the print head. Also, in a case where the print medium is transparent, the print head may be capable of ejecting a light-shielding ink, such as a white (W) ink, in addition to the four types of color inks, namely the black (K), cyan (C), magenta (M), and yellow (Y) inks.

Also, the print head 10 is provided with circulation units 54. The printing apparatus 1 is provided with ink tanks (not illustrated) as ink supply sources. The inks stored in the ink tanks are supplied to the print head 10 through supply tubes 29. The print head 10 circulates the inks supplied from the ink tanks within the print head 10 by using the circulation units 54. Details of the circulation units 54 will be described later.

The air blow unit 300 and the fixing unit 350 (see FIG. 10 to be described later) heat and dry applied aqueous inks on the printed print medium P. Details of the air blow unit 300 and the fixing unit 350 will be described later. Note that the air blow unit 300 and the fixing unit 350 also have a function of heating the water-soluble fine resin particles to be described later to form them into a film. The water-soluble fine resin particles form a film by being heated after being applied onto the print medium to thereby improve the scratch resistance of the image.

### Configuration of Print Head

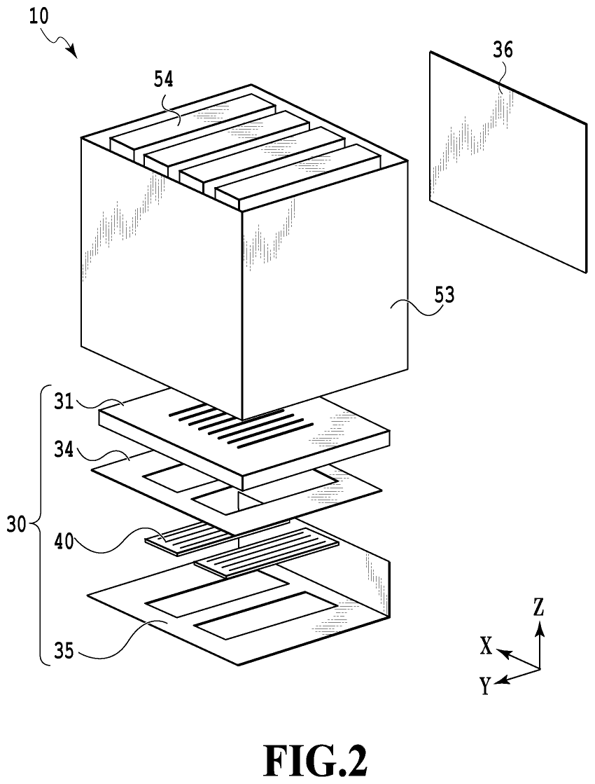

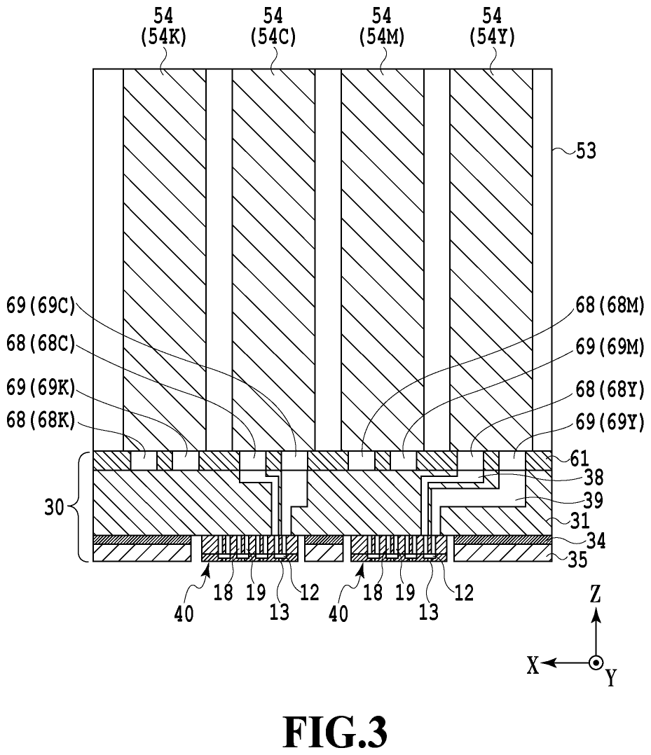

FIG. 2 is an exploded perspective view of the print head 10 in the present embodiment. FIG. 3 is a cross-sectional view illustrating the inside of the print head 10. As illustrated in FIGS. 2 and 3, the print head 10 includes a head housing 53, the circulation units 54, and an ejection unit 30 for ejecting the inks supplied from the circulation units 54 onto the print medium P. The print head 10 is fixed to and supported on the carriage 20 of the printing apparatus 1 by a positioning unit and electric contacts not illustrated which are provided to the carriage 20. The print head 10 performs printing on the print medium P by ejecting the inks while moving along with the carriage 20 in the main scanning direction (X direction).

As described above, the print head 10 is capable of ejecting four types of inks. In the present embodiment, in which four types of inks are used, there are provided four sets of an ink tank, supply tube 29, and liquid connector insertion slot (not illustrated) of the print head 10 corresponding respectively to the inks, and four supply paths corresponding respectively to the inks are formed independently of one another.

A circulation unit 54K for the black ink, a circulation unit 54C for the cyan ink, a circulation unit 54M for the magenta ink, and a circulation unit 54Y for the yellow ink are provided as the circulation units 54. The four circulation units 54K, 54C, 54M, and 54Y are contained inside the head housing 53 side by side in the X direction. The circulation units have substantially the same configuration, and each circulation unit will be denoted as “circulation unit 54” in the present embodiment unless otherwise distinguished. Note that the print head 10 illustrated in FIG. 2 represents an example where four circulation units 54 corresponding to the four types of inks are included in the print head 10, but it suffices that the circulation units 54 included correspond to the types of liquids to be ejected. Also, a plurality of circulation units 54 may be included for the same type of liquid. In sum, the print head 10 can have a configuration including one or more circulation units. The print head 10 may be configured not to circulate all of the four types of inks but only circulate at least one of the inks.

The ejection unit 30 includes two ejection modules 40, a first support member 31, a second support member 34, an electric wiring member (electric wiring tape) 35, and an electric contact substrate 36. Each ejection module 40 includes a silicon substrate made of silicon (not illustrated) and a plurality of printing elements and heating elements provided at one surface of the silicon substrate. The printing elements each include a heating resistance element (heater) that generates thermal energy for ejecting an ink. Each printing element is supplied with electric power through an electric wiring formed on the silicon substrate by a film forming technique. The heating elements each include a heating resistance element, like the printing elements, and heats the print head 10 to adjust temperature. Each heating element is supplied with electric power through an electric wiring formed on the silicon substrate by a film forming technique. The heating resistance element has such an electric resistance that, for example, as an electric current flows through the printing element, the printing element generates heat, causing film boiling of the ink.

On the front side of each ejection module 40 (silicon substrate), a plurality of pressure chambers 12 corresponding to the plurality of printing elements and a plurality of ejection ports 13 through which to eject the inks are formed by a photolithographic technique. In the silicon substrate, common supply channels 18 and common collection channels 19 are formed such that the inks supplied to the pressure chambers 12 may be circulated. Furthermore, in the silicon substrate, there are formed supply connection channels (not illustrated) through which the common supply channels 18 and the pressure chambers 12 communicate with one another, and collection connection channels (not illustrated) through which the common collection channels 19 and the pressure chambers 12 communicate with one another. In the back surface of the silicon substrate, there are formed ink supply ports (not illustrated) through which the common supply channels 18 and ink supply channels 38 in the first support member 31 communicate with one another, and ink collection ports (not illustrated) through which the common collection channels 19 and ink collection channels 39 in the first support member 31 communicate with one another.

In the present embodiment, one ejection module 40 is configured to eject two types of inks. Specifically, of the two ejection modules 40 illustrated in FIG. 3, the ejection module 40 located on the left side in the figure ejects the black and cyan inks, and the ejection module 40 located on the right side in the figure ejects the magenta and yellow inks. Note that the configuration of the ejection unit 30 may such that it includes one ejection module configured to eject the four types of inks.

The back surfaces of the ejection modules 40 (silicon substrates) are adhesively fixed to one surface (the lower surface in FIG. 3) of the first support member 31. In the first support member 31, the ink supply channels 38 and the ink collection channels 39 are formed, which penetrate therethrough from the one surface to the opposite surface. The openings of the ink supply channels 38 on one side communicate with the ink supply ports in the silicon substrates. The openings of the ink collection channels 39 on the one side communicate with the ink collection ports in the silicon substrates. Note that the ink supply channels 38 and the ink collection channels 39 are provided independently for each type of ink.

Also, the second support member 34 having openings to insert the ejection modules 40 is adhesively fixed to the one surface of the first support member 31. The electric wiring member 35 to be electrically connected to the ejection modules 40 is held on the second support member 34. The electric wiring member 35 sends electric signals for ink ejection to the ejection modules 40.

A joint member 61 is provided between the first support member 31 and the circulation units 54. In the joint member 61, a supply port 68 and a collection port 69 are formed for each type of ink. Through the supply ports 68 and the collection ports 69, the ink supply channels 38 and the ink collection channels 39 in the first support member 31 and channels formed in the circulation units 54 communicate with each other. Incidentally, in FIG. 3, a supply port 68K and a collection port 69K are for the black ink, and a supply port 68C and a collection port 69C are for the cyan ink. Moreover, a supply port 68M and a collection port 69M are for the magenta ink, and a supply port 68Y and a collection port 69Y are for the yellow ink.

Note that the openings of the ink supply channels 38 and the ink collection channels 39 in the first support member 31 on the one side have small opening areas matching the ink supply ports and the ink collection ports in the ejection modules 40 (silicon substrates). On the other hand, the openings of the ink supply channels 38 and the ink collection channels 39 in the first support member 31 on the opposite side have large opening areas matching the supply ports 68 and the collection ports 69 in the joint member 61 communicating with channels in the circulation units 54.

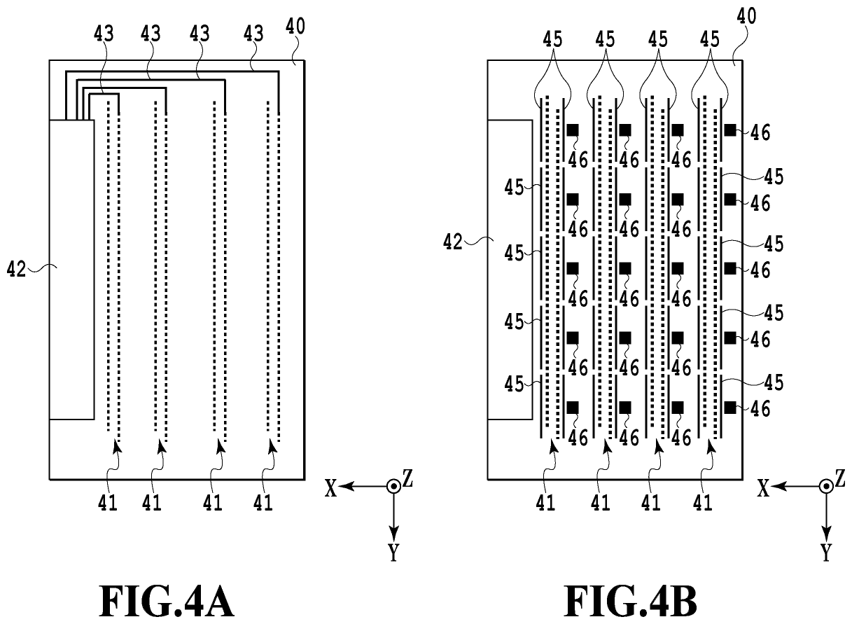

FIGS. 4A and 4B are schematic views illustrating electric wirings of an ejection module 40. FIG. 4A is a schematic view illustrating a layer where electric wirings 43 for supplying power to the printing elements are formed. FIG. 4B is a schematic view illustrating a layer where electric wirings for supplying power to the heating elements are formed. Incidentally, by forming the silicon substrate of the ejection module 40 in a multi-layer structure, the electric wirings 43 for the printing elements and the electric wirings for the heating elements can be formed at the same positions in an XY plane.

As illustrated in FIG. 4A, the ejection module 40 is provided with printing element arrays 41 each of which is a plurality of printing elements arrayed in the sub scanning direction (Y direction). For example, a plurality of printing element arrays 41 corresponding to the four types of inks, namely the black (K), cyan (C), magenta (M), and yellow (Y) inks, are disposed side by side in the main scanning direction (X direction). Also, the ejection module 40 is provided with an electric pad 42 electrically connected to the printing element arrays 41 through the electric wirings 43. Four electric wirings 43 corresponding individually to the four types of inks are electrically connected to the plurality of printing element arrays 41 and the electric pad 42. In this way, one electric wiring is connected to the printing element arrays 41 corresponding to one type of ink. An electric signal for driving a printing element contains a number of pieces of information. Connecting one electric wiring 43 to the printing element arrays 41 corresponding to one type of ink can simplify the structure of the electric wirings 43 and thus keep the manufacturing costs and size of the ejection module 40 from increasing. The electric wiring member 35 send electric signals for driving the printing elements in the printing element arrays 41 to the printing elements through the electric pad 42 and the electric wirings 43.

As illustrated in FIG. 4B, the ejection module 40 is provided with a plurality of heating elements 45 aligned in the array direction of the printing elements. The heating elements 45 are disposed with printing element arrays 41 interposed therebetween. For the heating elements 45, a material that generates heat in response to an electric current flowing therethrough, such as aluminum, is used. Also, the ejection module 40 is provided with a plurality of temperature sensors 46 aligned in the array direction of the printing elements. The temperature sensors 46, which are temperature detectors, are each constructed using a diode and detect the temperature of the print head 10 (ejection module 40). The heating elements 45 and the temperature sensors 46 are each electrically connected to the electric pad 42 through an electric wiring (not illustrated). The electric wiring member 35 sends electric signals for driving the heating elements 45 to the heating elements 45 through the electric pad 42 and the electric wirings. The temperature sensors 46 outputs temperature detection signals through the electric wirings and the electric pad 42.

In the example illustrated in FIGS. 4A and 4B, a plurality of printing element arrays 41 corresponding to the four types of inks are disposed on the ejection module 40 in order to facilitate the understanding, but the arrangement is not limited to this. For example, of the two ejection modules 40 illustrated in FIG. 3, the ejection module 40 that ejects the black and cyan inks may have a plurality of printing element arrays 41 for these two types of inks disposed side by side in the main scanning direction. Of the two ejection modules 40 illustrated in FIG. 3, the ejection module 40 that ejects the magenta and yellow inks may have a plurality of printing element arrays 41 for these two types of inks disposed side by side in the main scanning direction.

Circulation Path inside Print Head

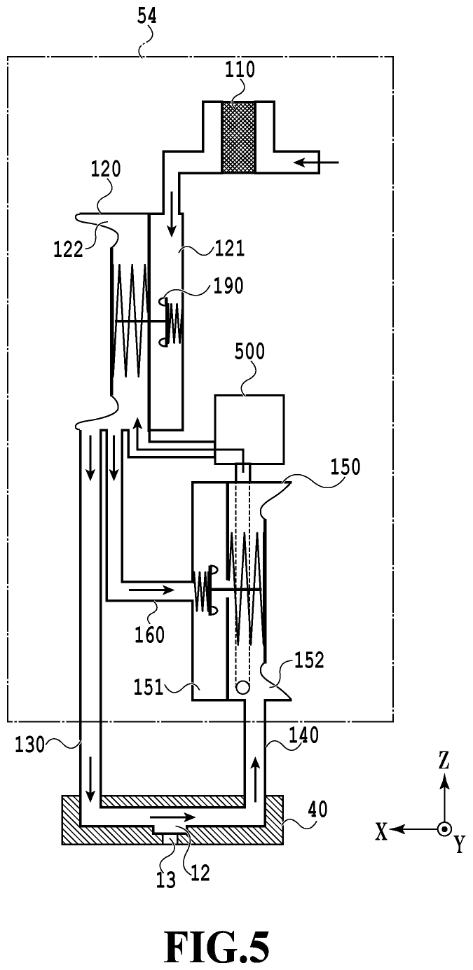

FIG. 5 is a schematic view illustrating a circulation path for one type of ink (ink of one color) formed inside the print head 10. As illustrated in FIG. 5, each circulation unit 54 includes a filter 110, a first pressure adjustment mechanism 120, a second pressure adjustment mechanism 150, and a circulation pump 500. The first pressure adjustment mechanism 120, the second pressure adjustment mechanism 150, and the circulation pump 500 are connected to one another by channels illustrated in FIG. 5, and form a circulation path in the print head 10 through which to supply and collect the ink to and from the ejection module 40.

The first pressure adjustment mechanism 120 includes a first valve chamber 121 and a first pressure control chamber 122. The second pressure adjustment mechanism 150 includes a second valve chamber 151 and a second pressure control chamber 152. The first pressure adjustment mechanism 120 is configured such that the controlled pressure therein is higher than that in the second pressure adjustment mechanism 150. In the present embodiment, these two pressure adjustment mechanisms 120 and 150 are used to implement circulation within a certain pressure range inside the circulation path. Also, the configuration is such that the ink flows through the pressure chambers 12 at a flow rate corresponding to the pressure difference between the first pressure adjustment mechanism 120 and the second pressure adjustment mechanism 150. The flow of the ink in the circulation path will be described below with reference to FIG. 5. Note that the arrows in FIG. 5 indicate the flow direction of the ink.

The ink stored in the ink tank (not illustrated) is pressurized by a pressure pump (not illustrated) provided in the printing apparatus 1 to thereby become an ink flow at a positive pressure and be supplied to the circulation unit 54 of the print head 10. The ink supplied to the circulation unit 54 passes through the filter 110, so that foreign substances such as dust and bubbles are removed. The ink then flows into the first valve chamber 121 provided in the first pressure adjustment mechanism 120. The pressure on the ink drops due to the pressure loss by the passage through the filter 110, but the pressure on the ink is still positive at this point. Thereafter, in a case where a valve 190 is open, the ink having flowed into the first valve chamber 121 flows into the first pressure control chamber 122. The pressure on the ink having flowed into the first pressure control chamber 122 switches from positive to negative as a result of the pressure loss by the passage through a communication port communicating with the first valve chamber 121 and the first pressure control chamber 122.

The circulation pump 500 operates to send the ink sucked in from the second pressure control chamber 152 to the first pressure control chamber 122. As the circulation pump 500 is driven, the ink having flowed into the first pressure control chamber 122 from the first valve chamber 121 flows into a supply channel 130 and a bypass channel 160 along with the ink sent from the second pressure control chamber 152. Note that the supply channel 130 is connected to the common supply channels 18 through the ink supply ports (not illustrated) provided in the ejection module 40. The supply channel 130 is formed by a channel formed in the circulation unit 54, the supply port 68 in the joint member 61, and the ink supply channel 38 in the first support member 31.

The ink having flowed into the supply channel 130 flows into the pressure chambers 12 from the ink supply ports in the ejection module 40 through the common supply channels 18. Part of that ink is ejected from the ejection ports 13 as the printing elements are driven (generate heat). Also, the remaining ink not used in the ejection flows through the pressure chambers 12 and passes through the common collection channels 19. Thereafter, the ink flows into a collection channel 140 connected to the ejection module 40. The ink having flowed into the collection channel 140 flows into the second pressure control chamber 152 of the second pressure adjustment mechanism 150. Note that the collection channel 140 is connected to the common collection channels 19 through the ink collection ports (not illustrated) provided in the ejection module 40. The collection channel 140 is formed by a channel formed in the circulation unit 54, the collection port 69 in the joint member 61, and the ink collection channel 39 in the first support member 31.

On the other hand, the ink having flowed into the bypass channel 160 from the first pressure control chamber 122 flows into the second valve chamber 151 and into the second pressure control chamber 152. The ink having flowed into the second pressure control chamber 152 through the bypass channel 160 and the ink collected from the collection channel 140 are sent to the first pressure control chamber 122 by the circulation pump 500. Thereafter, the ink flowing into the second pressure control chamber 152 from the first pressure control chamber 122 through the supply channel 130 and the ejection module 40 and the ink flowing into the second pressure control chamber 152 through the bypass channel 160 will flow into the circulation pump 500. The inks are then sent from the circulation pump 500 to the first pressure control chamber 122. The ink circulation is performed within the circulation path in this manner.

### Configuration of Circulation Pump

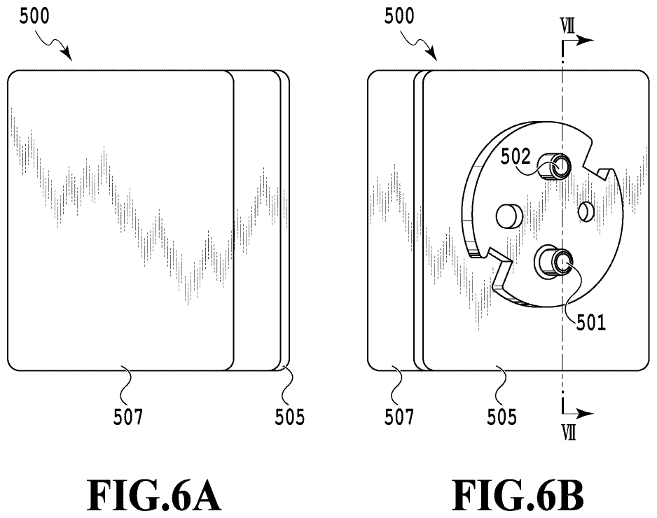

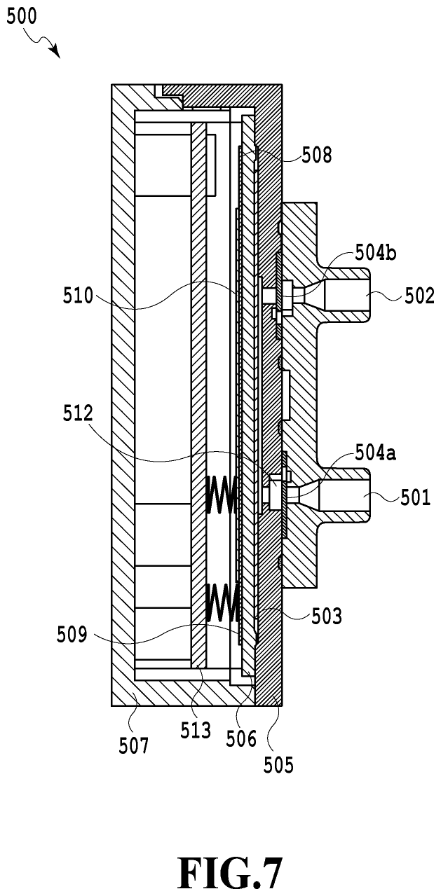

Next, the circulation pump 500 will be described with reference to FIGS. 6A, 6B, and 7. FIGS. 6A and 6B are perspective views of the circulation pump 500. FIG. 6A is a perspective view illustrating the back side of the circulation pump 500. FIG. 6B is a perspective view illustrating the front side of the circulation pump 500. An outer shell of the circulation pump 500 includes a pump housing 505 and a cover 507 fixed to the pump housing 505. In the pump housing 505, a pump supply hole 501 and a pump discharge hole 502 are formed. The pump supply hole 501 is connected to the second pressure control chamber 152. The pump discharge hole 502 is connected to the first pressure control chamber 122. The ink flows into the circulation pump 500 from the pump supply hole 501, passes through a pump chamber 503 (see FIG. 7) provided inside the circulation pump 500, and gets discharged from the pump discharge hole 502.

FIG. 7 is a cross-sectional view of the circulation pump 500 illustrating a cross section taken along the VII-VII line in FIG. 6B. A diaphragm 506 is joined to the inner surface of the pump housing 505, and the pump chamber 503 is formed between this diaphragm 506 and a recess formed in the inner surface of the pump housing 505. The pump chamber 503 communicates with the pump supply hole 501 and the pump discharge hole 502, which are formed in the pump housing 505. Also, a check valve 504a is provided at an intermediate portion of the pump supply hole 501. A check valve 504b is provided at an intermediate portion of the pump discharge hole 502.

As the diaphragm 506 gets displaced to increase the inner volume of the pump chamber 503, the pump chamber 503 gets depressurized. In response to this, the check valve 504a gets separated from the opening of the pump supply hole 501 in a space 512. By getting separated from the opening of the pump supply hole 501 in the space 512, the check valve 504a shifts to an open state in which the ink is allowed to flow through the pump supply hole 501. Also, as the diaphragm 506 gets displaced to reduce the inner volume of the pump chamber 503, the pump chamber 503 gets pressurized. In response to this, the check valve 504a comes into tight contact with the wall surface around the opening of the pump supply hole 501. The check valve 504a is thus in a closed state in which the check valve 504a blocks the ink flow through the pump supply hole 501.

The check valve 504b, on the other hand, comes into tight contact with the wall surface around an opening formed in the pump housing 505 as the pump chamber 503 gets depressurized, thereby shifting to a closed state in which the check valve 504b blocks the ink flow through the pump discharge hole 502. Also, as the pump chamber 503 gets pressurized, the check valve 504b gets separated from the opening in the pump housing 505, thereby shifting to an open state in which the ink is allowed to flow through the pump discharge hole 502.

Note that the material of each of the check valves 504a and 504b only needs to be one that is deformable according to the pressure in the pump chamber 503. For example, each of the check valves 504a and 504b can formed of, but not limited to, an elastic member of an ethylene propylene diene monomer (EPDM), an elastomer, or the like or of a film or thin plate of polypropylene or the like.

As described above, the pump chamber 503 is formed by joining the pump housing 505 and the diaphragm 506. Thus, the pressure in the pump chamber 503 changes as the diaphragm 506 gets deformed. For example, in a case where the diaphragm 506 gets displaced toward the pump housing 505, thereby reducing the inner volume of the pump chamber 503, the pressure in the pump chamber 503 rises. As a result, the check valve 504b disposed to face the pump discharge hole 502 shifts to the open state, so that the ink in the pump chamber 503 gets discharged. At this time, the check valve 504a disposed to face the pump supply hole 501 is in tight contact with the wall surface around the pump supply hole 501, thereby preventing backflow of the ink from the pump chamber 503 into the pump supply hole 501.

Conversely, in a case where the diaphragm 506 gets displaced in the direction in which the pump chamber 503 widens, the pressure in the pump chamber 503 decreases. As a result, the check valve 504a disposed to face the pump supply hole 501 shifts to the open state, so that the ink is supplied into the pump chamber 503. At this time, the check valve 504b disposed to face the pump discharge hole 502 comes into tight contact with the wall surface around an opening formed in the pump housing 505 to close this opening. This prevents backflow of the ink from the pump discharge hole 502 into the pump chamber 503.

As described above, in the circulation pump 500, by deforming the diaphragm 506 to change the pressure in the pump chamber 503, the ink is sucked in and discharged to perform circulation control which causes the ink to circulate through the circulation path. At this time, the number of times to deform the diaphragm 506 per unit time can be changed to change the circulatory flow velocity of the ink circulating through the circulation path. Hereinafter, the number of times to deform the diaphragm 506 per unit time will be referred to as “the number of times to drive the circulation pump.”

### Driving Unit of Diaphragm

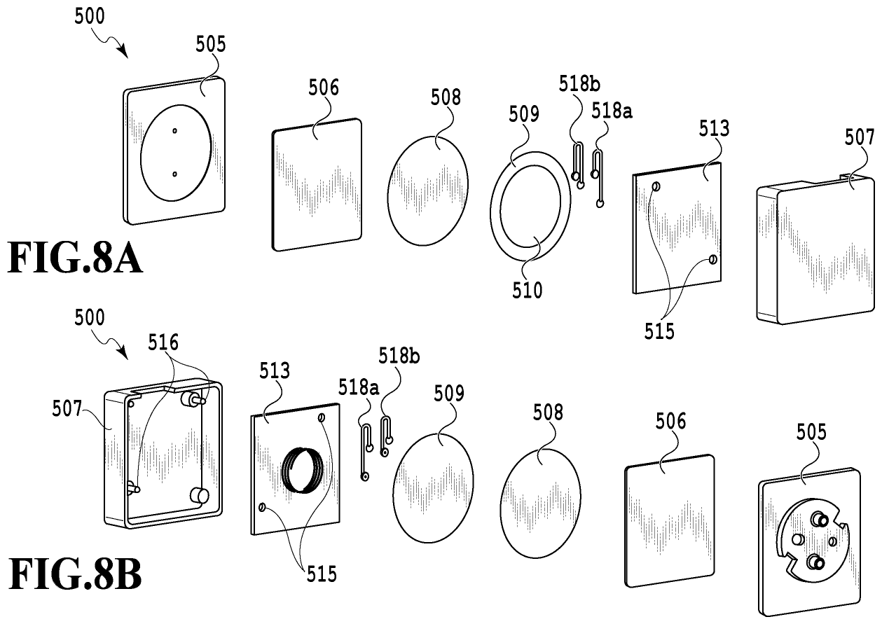

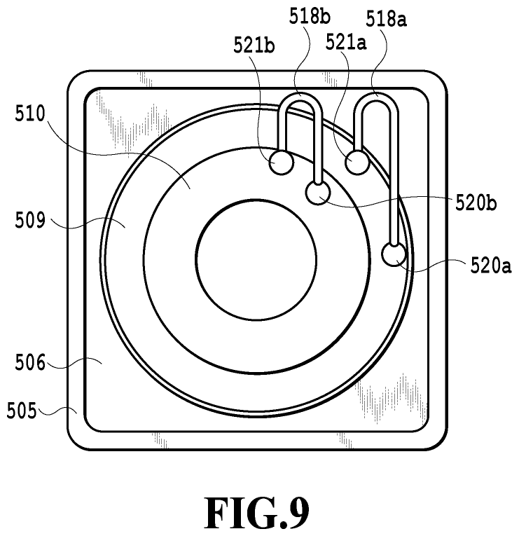

Next, a driving unit of the diaphragm 506 will be described with reference to FIGS. 8A, 8B, and 9. FIGS. 8A and 8B are exploded perspective views of the circulation pump 500. FIG. 8A is an exploded perspective view of the circulation pump 500 as seen from the back side. FIG. 8B is an exploded perspective view of the circulation pump 500 as seen from the front side. The circulation pump 500 is a piezoelectric pump which is driven by applying a voltage to its piezoceramic member. As illustrated in FIGS. 8A and 8B, the diaphragm 506, a vibration plate 509, a piezoceramic member 510, and a driving circuit board 513 are provided inside the circulation pump 500.

The diaphragm 506 is formed in a thin plate shape using an injection-moldable resin material, such as a modified polyphenylene ether, which is a blend of a polyphenylene ether (PPE) resin and polystyrene (PS), or polypropylene. Also, the diaphragm 506 may be formed by cutting out of a film or a resin plate, but is not limited to this. The diaphragm 506 is bonded one surface of the vibration plate 509 with an adhesive agent 508. The vibration plate 509 is formed in a thin plate shape using brass, stainless steel, an iron-nickel alloy, or the like, but is not limited to this. The piezoceramic member 510 is adhesively fixed to the surface of the vibration plate 509 on the opposite side from the diaphragm 506. The driving circuit board 513 is fixed to the inner side of the cover 507 while facing the piezoceramic member 510. The driving circuit board 513 drives the piezoceramic member 510 and the vibration plate 509 by applying voltages to them using power supplied from the printing apparatus 1. In the driving circuit board 513, board holes 515 to be engaged with fixing pins 516 formed on the inner side of the cover 507 are formed.

FIG. 9 is a cross-sectional view illustrating the piezoceramic member 510 and its vicinity inside the circulation pump 500. FIG. 9 illustrates an electric connection portion of the piezoceramic member 510 seen through from the driving circuit board 513 side. The vibration plate 509 is electrically connected to a ground (GND) wiring in the driving circuit board 513 through a first electric connection cable 518a. The piezoceramic member 510 is electrically connected to an alternating current (AC) voltage output of the driving circuit board 513 through a second electric connection cable 518b. One end of the first electric connection cable 518a is fixed and electrically connected to the vibration plate 509 by solder 520a. The opposite end of the first electric connection cable 518a is fixed and electrically connected to the driving circuit board 513 (GND wiring) by solder 521a. One end of the second electric connection cable 518b is fixed and electrically connected to the piezoceramic member 510 by solder 520b. The opposite end of the second electric connection cable 518b is fixed and electrically connected to the driving circuit board 513 (AC voltage output) by solder 521b. By connecting the vibration plate 509 to GND (ground) and applying an AC voltage to the piezoceramic member 510, the piezoceramic member 510 gets stretched and shrunk to deform the diaphragm 506. By deforming the diaphragm 506, the circulation pump 500 can change the pressure in the pump chamber 503 and thereby suck in and discharge the ink.

Also, the driving circuit board 513 is electrically connected through a cable (not illustrated) to a connection terminal for driving the pump provided to the electric contact substrate 36 (see FIG. 2). In a case where the print head 10 is mounted on the carriage 20, an electric signal from an electric contact on the carriage 20 side is input into the driving circuit board 513 from the connection terminal of the electric contact substrate 36 for driving the pump through a cable. By providing the electric contact substrate 36 with the connection terminal for driving the pump, the circulation pump 500 can be driven by applying a predetermined voltage to the connection terminal even in a state where the print head 10 is detached from the carriage 20.

### Configurations of Air Blow Unit and Fixing Unit

Next, the air blow unit 300 and the fixing unit 350 will be described with reference to FIG. 10. FIG. 10 is a cross-sectional view illustrating the air blow unit 300 and the fixing unit 350. The air blow unit 300 and the fixing unit 350 fixes the inks forming an image on the print medium P to the print medium P by drying the inks through heating. The air blow unit 300 is disposed upstream (in the conveyance direction of the print medium P) and in the vicinity of the print head 10 located above a platen 23. The air blow unit 300 is an air blowing-type drying device, and sends a gas to a portion of the print medium P facing the print head 10. The air blow unit 300 includes a first heat generation member 310 for heating the gas and a first air blow unit 320. The first heat generation member 310 is disposed inside a first air blow duct 322 of the first air blow unit 320. The first heat generation member 310 only needs to be capable of controlling the heating temperature for heating the gas. Also, the first heat generation member 310 is preferably such that its efficiency of heat transfer to air is high.

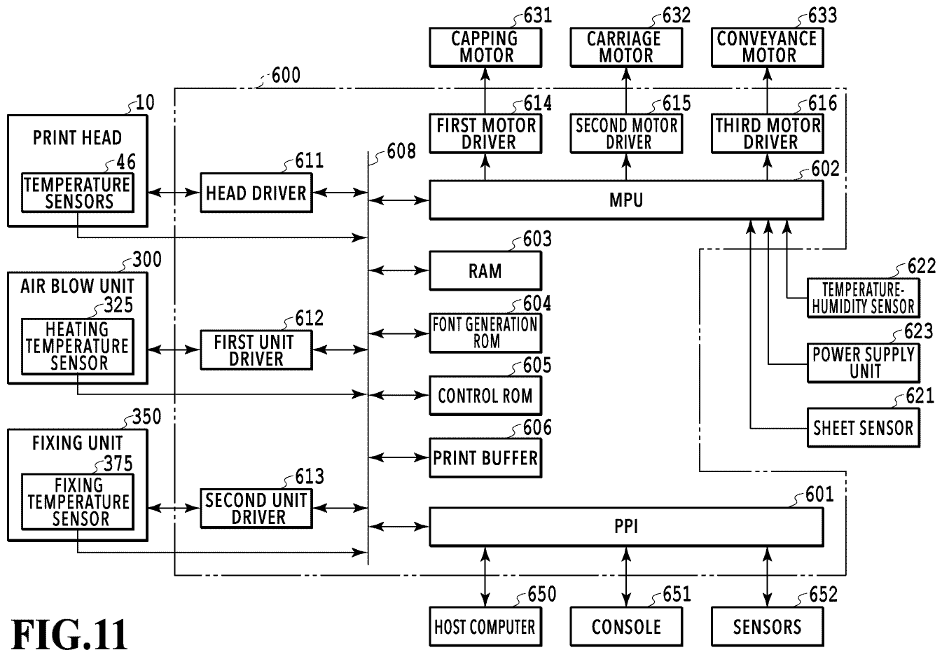

The first air blow unit 320 includes a first air blow fan 321, the first air blow duct 322, and a first air blow and discharge unit 323. The first air blow fan 321 sends a gas (e.g., air) to the first heat generation member 310. The first heat generation member 310 heats the gas sent from the first air blow fan 321. The first air blow duct 322 guides the gas heated by the first heat generation member 310 to the first air blow and discharge unit 323. The first air blow and discharge unit 323 discharges the gas that has been heated by the first heat generation member 310 and passed through the first air blow duct 322 toward the gap between the print head 10 and the print medium P (platen 23). In this way, the first air blow unit 320 sends the gas heated by the first heat generation member 310 to a portion of the print medium P facing the print head 10. Also, a heating temperature sensor 325 (see FIG. 11 to be described later) is attached to the inner side of the first air blow duct 322, and the heating temperature for heating the gas with the first heat generation member 310 can be controlled based on the temperature detected by the heating temperature sensor 325. The heating temperature sensor 325 is constructed using an infrared sensor or the like, for example.

Note that the air blow unit 300 may be provided with a vapor discharge mechanism that collects vapor generated from the inks and discharge them to the outside. Depending on the amount of the inks attached to the print medium P, the drying of the inks may result in generation of a large amount of vapor. Providing the air blow unit 300 with the vapor discharge mechanism can prevent the inside of the air blow unit 300 from being filled with the vapor, lowering the drying efficiency. Also, an access cover 390 covers the air blow unit 300 and the print head 10 from above. In the side portion of the access cover 390 in the +Y direction (the downstream side in the conveyance direction of the print medium P), a plurality of opening portions (not illustrated) are formed through which to release the gas discharged from the first air blow and discharge unit 323 of the air blow unit 300.

The fixing unit 350 is disposed downstream (in the conveyance direction of the print medium P) of the print head 10 above the print medium P. Note that the downstream conveyance rollers 27 and 28 are disposed upstream (in the conveyance direction of the print medium P) of the fixing unit 350 in FIG. 10, but may be disposed downstream of the fixing unit 350. The fixing unit 350 is an air blowing-type drying device, and dries the inks ejected onto the print medium P by the print head 10 to fix the inks. The fixing unit 350 includes a second heat generation member 360 for heating the gas and a second air blow unit 370. The second heat generation member 360 is disposed inside a second air blow duct 372 of the second air blow unit 370. The second heat generation member 360 only needs to be capable of controlling the fixing temperature for fixing the inks. Also, the second heat generation member 360 is preferably such that its efficiency of heat transfer to air is high.

The second air blow unit 370 includes a second air blow fan 371, the second air blow duct 372, and a second air blow and discharge unit 373. The second air blow fan 371 sends a gas (e.g., air) to the second heat generation member 360. The second heat generation member 360 heats the gas sent from the second air blow fan 371. The second air blow duct 372 guides the gas heated by the second heat generation member 360 to the second air blow and discharge unit 373. The second air blow and discharge unit 373 is formed in the form of a mesh facing the print medium P. The second air blow and discharge unit 373 discharges the gas that has been heated by the second heat generation member 360 and passed through the second air blow duct 372 toward the print medium P. In this way, the second air blow unit 370 blows the gas heated by the second heat generation member 360 onto the print medium P, thereby drying the inks ejected onto the print medium P by the print head 10. Also, a fixing temperature sensor 375 (see FIG. 11 to be described later) is attached to the inner side of the second air blow duct 372. The fixing temperature for fixing the inks with the fixing unit 350 can be controlled based on the temperature detected by the fixing temperature sensor 375. The fixing temperature sensor 375 is constructed using an infrared sensor or the like, for example.

Note that, like the air blow unit 300, the fixing unit 350 may be provided with a vapor discharge mechanism that collects vapor generated from the inks and discharge them to the outside. Also, the second air blow unit 370 is configured to take the atmospheric air in, but is not limited to this. For example, the second air blow unit may include an adjustment mechanism that adjusts the amount of atmospheric air to be taken in. Also, the second air blow unit may be configured to circulate the gas heated by the second heat generation member between the second air blow duct and the print medium. In this way, as compared to the case of taking atmospheric air in, the amount of heat for heating the gas is low, and therefore the power consumption of the second heat generation member can be reduced.

Also, in the fixing of the inks by the fixing unit 350, it is necessary to evaporate most of the liquid components contained in the inks, such as their water-soluble organic solvents. Thus, the temperature distribution at the second air blow and discharge unit 373 in the conveyance direction of the print medium P is a temperature distribution that can ensure a heating time for supplying an amount of energy required to evaporate most of the liquid components.

In the present embodiment, the inks forming the image on the print medium P are fixed to the print medium P by undergoing the first drying process by the air blow unit 300 and the second drying process by the fixing unit 350. In first drying process, the air blow unit 300 sends a heated gas to a portion of the print medium P facing the print head 10 to dry the inks on the print medium P. As a result, the liquid components contained in the inks get evaporated, increasing the viscosity of the inks. This makes it possible to reduce deterioration of the surface shape of the ink film on the print medium P or deterioration of the image in the second drying process by the fixing unit 350. In the first drying process, in which the viscosity of the inks has not been sufficiently increased, blowing a gas onto the print medium P from the side where the print head 10 is disposed may affect the surface shape of the ink film on the print medium P. Hence, it is preferable that the air blow unit 300 blow air in a direction along the print medium P so as not to affect the surface shape of the ink film on the print medium P.

Also, in the first drying process, it is preferable to control the temperature of the first heat generation member 310 such that the temperature of the gas sent from the air blow unit 300 will be higher than the region where the image is printed by the print head 10. In this way, in a case of using the inks in large amounts to print an image, it is possible to avoid a situation where it takes time for the inks on the print medium P to dry and increase the viscosity of the inks, thus causing defects in the image printed on the print medium P. For example, the temperature of the gas sent from the air blow unit 300 is preferably 35° C. or more and 60° C. or less. This can increase the efficiency of drying of the inks on the print medium P. If the temperature of the gas sent from the air blow unit 300 is not sufficiently high, the section for performing the first drying process in a high-speed printing mode needs to be long.

In the second drying process, the fixing unit 350 further dries the inks on the print medium P having undergone the first drying process to thereby fix the inks. At this time, the fixing unit 350 dries the inks on the print medium P by rapidly heating the inks at such a rate as to keep the inks from flowing, to thereby fix the inks to the print medium P.

Also, in a case of using the water-soluble fine resin particle inks to be described later, the fine resin particles contained in the inks are heated by the air blow unit 300 and the fixing unit 350 to be formed into a film. The temperature for heating the water-soluble fine resin particle inks (fixing temperature) is desirably a higher temperature than the minimum film-forming temperature of the fine resin particles. Note that the minimum film-forming temperature refers to the minimum temperature necessary for the fine resin particles to form a film through heating. In a case where a dry product obtained by spreading the fine resin particles over a thermally conductive plate with a temperature gradient forms a uniform and continuous dry film, the lowest temperature at which the film does not turn white can be measured as the minimum film-forming temperature. Also, in the high-speed printing mode, the inks need to be dried within a limited section. To enhance the ink drying efficiency, the temperature for heating the water-soluble fine resin particle inks (fixing temperature) is preferably higher. For example, the temperature for heating the water-soluble fine resin particle inks may be 60° C. or more and 80° C. or more. Also, to prevent deformation of the print medium, the temperature for heating the water-soluble fine resin particle inks may be 120° C. or less and 100° C. or less.

### Ink Compositions

Next, the compositions of the color inks and water-soluble fine resin particle inks used in the present embodiment will be described. In the following, “part” and “%” are based on mass, unless otherwise noted.

The color inks containing pigments and the water-soluble fine resin particle inks containing no pigment or a small amount of a pigment that are used in the present embodiment each contain a water-soluble organic solvent. The water-soluble organic solvent is preferably one with a boiling point of 150° C. or more and 300° C. or less in view of the wettability and moisture retentiveness of the orifice face of the print head. Also, from the viewpoint of the function of a film formation aid for the fine resin particles and the swelling and dissolution into the print medium on which a resin layer is formed, the water-soluble organic solvent is preferably any of the following: ketone-based compounds such as acetone and cyclohexanone; propylene glycol derivatives such as tetraethylene glycol dimethyl ether; and heterocyclic compounds having a lactam structure as represented by N-methyl-pyrrolidone and 2-pyrrolidone. From the viewpoint of ejection performance, the content of the water-soluble organic solvent is preferably 3 wt% or more and 30 wt% or less. Specific examples of the water-soluble organic solvent include the following examples: alkyl alcohols having one to four carbon atoms such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones or keto-alcohols such as acetone and diacetone alcohol; ethers such as tetrahydrofuran and dioxane; polyalkylene glycols such as polyethylene glycol and polypropylene glycol; ethylene glycol; alkylene glycols with an alkylene group having two to six carbon atoms such as propylene glycol, butylene glycol, triethylene glycol, 1,2,6-hexane triol, thiodiglycol, hexylene glycol, and diethylene glycol; lower alkyl ether acetates such as polyethylene glycol monomethyl ether acetate; glycerin; and lower alkyl ethers of polyhydric alcohols such as ethylene glycol monomethyl (or ethyl) ether, diethylene glycol methyl (or ethyl) ether, and triethylene glycol monomethyl (or ethyl) ether; polyalcohols such as trimethylolpropane and trimethylolethane; N-methyl-2-pyrrolidone; 2-pyrrolidone; 1,3-dimethyl-2-imidazolidinone; and the like. The above-listed water-soluble organic solvents can be used alone or as a mixture. Deionized water is desirably used as the water. Besides the above components, a surfactant, a defoamer, a preservative, a mildewproofing agent, and the like may be added as appropriate to each of the color inks and water-soluble fine resin particle inks used in the present embodiment in order to impart desired physical properties.

### Preparation of Fine Resin Particle Dispersion Liquid

The color inks in the present embodiment each contain water-soluble fine resin particles intended to allow tight contact between the print medium and the color material to improve the scratch resistance (fixability) of the printed image. The fine resin particles melts with heat, and a heater is used to form the fine resin particles into a film and dry the solvent contained in the ink. The term “fine resin particles” in the present embodiment refers to fine polymer particles present in a dispersed state in water. Specific examples of the fine resin particles include the following examples: fine particles of an acrylic resin synthesized by emulsion polymerization or the like of a monomer of a (meth)acrylic acid alkyl ester, a (meth)acrylic acid alkyl amide, or the like; fine particles of a styrene-acrylic resin synthesized by emulsion polymerization or the like of monomers of a (meth)acrylic acid alkyl ester, a (meth)acrylic acid alkyl amide, or the like and styrene; fine particles of a polyethylene resin; fine particles of a polypropylene resin; fine particles of a polyurethane resin; fine particles of a styrene-butadiene resin; and the like. Also, the fine resin particles may be: core-shell type fine resin particles being fine resin particles each formed of a core portion and a shell portion differing from each other in polymer composition; fine resin particles obtained by preparing fine acrylic particles as seed particles synthesized in advance in order to control the particle size and then allowing emulsion polymerization around the fine acrylic particles; or the like. The fine resin particles may be hybrid fine resin particles obtained by chemically binding different types of fine resin particles, such as fine acrylic resin particles and fine urethane resin particles, or the like.

Also, the “fine polymer particles present in a dispersed state in water” may be in the form of fine resin particles obtained by homopolymerizing a monomer having a dissociable group alone or by copolymerizing a plurality of kinds thereof, or a so-called self-dispersing resin particle dispersion. Examples of the dissociable group include carboxyl group, sulfonic acid group, and phosphoric acid group, and examples of monomers having these dissociable groups include acrylic acid, methacrylic acid, and the like. The “fine polymer particles present in a dispersed state in water” may be a so-called emulsion dispersion-type fine particle dispersion in which fine resin particles are dispersed using an emulsifier. As the emulsifier, materials having anionic charges can be used regardless of whether the molecular weight is low or high.

### Process Liquid

Also, in the present embodiment, a process liquid (RCT) is used for low-absorbency print media (poorly absorbent print media) and non-absorbent print media for the purpose of forming images. The process liquid used in the present embodiment contains a reactive component that reacts with the pigments contained in the inks to cause the pigments to aggregate or gel. Specifically, in a case where the process liquid is blended on a print medium or the like with an ink containing a pigment stably dispersed or dissolved in an aqueous medium by the function of an ionic group, this reactive component is a component that can destroy the stability of dispersion in the ink. In the present embodiment, anionic color materials are used. Thus, the reactant forming the reactive component in the process liquid is broadly classified as an acid-based reactant, a polyvalent metal-based reactant, or a cationic polymer-based reactant.

The acid-based reactant is broadly classified as an inorganic acid or an organic acid. In the present embodiment, a description will be given with an organic acid, but the acid-based reactant is not limited to an organic acid. Specific examples of water-soluble organic acids include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, and tartaric acid. Further specific examples of water-soluble organic acids include lactic acid, pyrrolidonecarboxylic acid, pyronecarboxylic acid, pyrrolecarboxylic acid, furancarboxylic acid, pyridinecarboxylic acid, coumalic acid, thiophenecarboxylic acid, nicotinic acid, oxysuccinic acid, and dioxysuccinic acid. The content of the organic acid is preferably 3.0% by mass or more and 90.0% by mass or less and more preferably 5.0% by mass or more and 70.0% by mass or less relative to the total mass of the compositions contained in the process liquid.

Examples of the polyvalent metal-based reactant include divalent metal ions such as Ca²⁺, Cu²⁺, Ni²⁺, Mg²⁺, Zn²⁺, Sr²⁺, and Ba²⁺. Examples of the polyvalent metal-based reactant also include, but not limited to, trivalent metal ions such as Al³⁺, Fe³⁺, Cr³⁺, and Y³⁺. For these polyvalent metal ions to be contained in the process liquid, salts of polyvalent metals may be used. A salt refers to a metal salt composed of polyvalent metal ions, such as those listed above, and anions that bind to these ions, and it is required to be water-soluble. Examples of preferred anions for forming a salt include, but not limited to, Cl⁻, NO3⁻, I⁻, Br⁻, ClO₃⁻, SO₄²⁻, CO₃²⁻, CH₃COO⁻, and HCOO⁻.

From the viewpoint of reactivity, coloring properties, ease of handling, and the like, preferable polyvalent metal ions are Ca²⁺, Mg²⁺, Sr²⁺, Al³⁺, and Y³⁺, among which Ca²⁺is particularly preferable. Also, from the viewpoint of safety and the like, methanesulfonic acid is particularly preferable as the anion for forming a salt with the polyvalent metal ion.

As the cationic polymer-based reactant, a water-soluble reactive agent is preferable. Specific examples of the cationic polymer include polyallylamine hydrochlorides, polyamine sulfonates, polyvinylamine hydrochlorides, and chitosan acetates. Further, specific examples of the cationic polymer include a copolymer of vinylpyrrolidone and an aminoalkylalkylate quaternary salt in which a part of the nonionic polymer substance is cationized, and a copolymer of acrylamide and an aminomethyl acrylamide quaternary salt. A process liquid containing a cationic polymer as a reactive component is preferably colorless, but does not necessarily have to be a liquid that absorbs light in the visible range. The process liquid containing a cationic polymer as a reactive component may be a light-colored liquid that absorbs light in the visible range as long as it does not substantially affect images formed on a print medium. Note that the process liquid does not necessarily have to be used in all printing mode, and is applied in a necessary amount taking into account the amount of the inks to be applied in image forming.

### Control System of Printing Apparatus

Next, a control system of the printing apparatus 1 will be described. FIG. 11 is a block diagram illustrating the control system of the printing apparatus 1. As illustrated in FIG. 11, the printing apparatus 1 further includes a controller 600. The controller 600 includes a programmable peripheral interface (PPI) 601, a micro processing unit (MPU) 602, a random access memory (RAM) 603, a font generation read only memory (ROM) 604, a control ROM 605, and a print buffer 606. Also, the controller 600 includes a head driver 611, a first unit driver 612, a second unit driver 613, a first motor driver 614, a second motor driver 615, and a third motor driver 616. The PPI 601, the MPU 602, the RAM 603, the font generation ROM 604, the control ROM 605, the print buffer 606, the head driver 611, the first unit driver 612, and the second unit driver 613 are connected to one another through a system bus 608.

A host computer 650, a console 651, and sensors 652 are connected to the PPI 601. The PPI 601 receives instruction signals (commands) and print information signals containing print data which are sent from the host computer 650, and transfers them to the MPU 602. Also, the PPI 601 sends status information of the printing apparatus 1 to the host computer 650 as necessary. The console 651 has a setting input unit with which the user configures various settings of the printing apparatus 1, a display unit which displays messages to the user, and the like. The PPI 601 receives and outputs data from and to the console 651. The sensors 652 include a home position sensor, capping sensor, and the like. Note that the home position sensor detects whether the carriage 20 or the print head 10 is at a home position. The PPI 601 receives input signals sent from the sensors 652.

The MPU 602 controls components of the printing apparatus 1 in accordance with a control program stored in the control ROM 605. The RAM 603 stores received data. The RAM 603 is used as a work area for the MPU 602 and is also used to temporarily store various pieces of data. The control ROM 605 can store data to be used in the standby control to be described later (e.g., data on the print head's standby temperature, standby start temperature, standby end temperature, etc.) in addition to the above control program. The print buffer 606 stores print data loaded to the RAM 603 or the like. The print buffer 606 has a capacity to hold a plurality of lines to be printed in the print data. The RAM 603, the font generation ROM 604, the control ROM 605, and the print buffer 606 are controlled by the MPU 602 through the system bus 608.

Also, a sheet sensor 621, a temperature-humidity sensor 622, and a power supply unit 623 are electrically connected to the MPU 602. The sheet sensor 621 is detects the presence or absence of a print medium, specifically, whether a print medium has been fed to a position where the print head 10 can perform printing. The temperature-humidity sensor 622 detects the environmental temperature and environmental humidity in the environment in which the printing apparatus 1 is installed. The power supply unit 623 supplies power to components of the printing apparatus 1. The power supply unit 623 has an AC adaptor and a battery as driving power supply devices.

The head driver 611 is connected to the MPU 602 through the system bus 608 and electrically connected to the print head 10. The head driver 611 drives the printing elements, the heating elements, the circulation pump 500, and the like of the print head 10 in accordance with control by the MPU 602. Also, the temperature sensors 46 of the print head 10 output their temperature detection signals to the MPU 602 through the system bus 608. The MPU 602 is capable of performing the standby control to be described later based on the temperature detection signals input from the temperature sensors 46.

The first unit driver 612 is connected to the MPU 602 through the system bus 608 and electrically connected to the air blow unit 300. The first unit driver 612 drives the first heat generation member 310, the first air blow fan 321, and the like of the air blow unit 300 in accordance with control by the MPU 602. Also, the heating temperature sensor 325 of the air blow unit 300 outputs its temperature detection signal to the MPU 602 through the system bus 608. Based on the temperature detection signal input from the heating temperature sensor 325, the MPU 602 controls the heating temperature for heating the gas with the first heat generation member 310 at a constant heating temperature. Note that the heating temperature or air blow speed at the air blow unit 300 is set according to the type and thickness of the print medium added to the print data, the environmental temperature and humidity in the ambient environment in which the printing apparatus 1 is installed, and so on. The user can set and change the heating temperature or air blow speed at the air blow unit 300 using, for example, the console 651, the operation panel (not illustrated) of the printing apparatus 1, or the like.

The second unit driver 613 is connected to the MPU 602 through the system bus 608 and electrically connected to the fixing unit 350. The second unit driver 613 drives the second heat generation member 360, the second air blow fan 371, and the like of the fixing unit 350 in accordance with control by the MPU 602. Also, the fixing temperature sensor 375 of the fixing unit 350 outputs its temperature detection signal to the MPU 602 through the system bus 608. Based on the temperature detection signal input from the fixing temperature sensor 375, the MPU 602 controls the fixing temperature for fixing the inks with the fixing unit 350 at a constant fixing temperature. Note that the fixing temperature or air blow speed at the fixing unit 350 is set according to the type and thickness of the print medium added to the print data, the environmental temperature and humidity in the ambient environment in which the printing apparatus 1 is installed, and so on. The user can set and change the fixing temperature or air blow speed at the fixing unit 350 using, for example, the console 651, the operation panel (not illustrated) of the printing apparatus 1, or the like.

The first motor driver 614 is electrically connected to the MPU 602 and electrically connected to a capping motor 631. The first motor driver 614 drives the capping motor 631 in accordance with control by the MPU 602. The second motor driver 615 is electrically connected to the MPU 602 and electrically connected to a carriage motor 632. The second motor driver 615 drives the carriage motor 632 in accordance with control by the MPU 602. The third motor driver 616 is electrically connected to the MPU 602 and electrically connected to a conveyance motor 633, which is a conveyance device. The third motor driver 616 drives the conveyance motor 633 in accordance with control by the MPU 602. The conveyance motor 633 rotationally drives the above-mentioned upstream conveyance rollers 25 and 26 and downstream conveyance rollers 27 and 28 (see FIG. 1).

In a case where the host computer 650 sends a print information signal containing print data through a parallel port, an infrared port, a network, or the like, a predetermined command is attached to the head of the print data. Examples of the predetermined commands include the type of the print medium to be subjected to the printing, the size of the print medium, the print quality, whether or not to perform automatic object determination, and the like. Also, in a case of applying a process liquid for improving the fixability of the inks to the print medium, information identifying whether or not to apply the liquid or the like may be added as the predetermined command. Note that examples of the type of the print medium include types such as plain paper, an overhead projector (OHP) sheet, and glossy paper as well as special types of printing media such as a transfer film, cardboard, and banner paper. Examples of the size of the print medium include A0, A1, A2, B0, B1, and B2. Examples of the print quality include draft, high definition, middle definition, exaggeration of a particular color, and monochrome or color. Also, the print data to which the predetermined command is attached is also called “print job.”

In accordance with the command attached to the head of the print data, the printing apparatus 1 (PPI 601) reads control data necessary for the printing out of the control ROM 605, and performs the printing based on the read control data. Examples of the control data include data for determining the number of passes to be repeated in multipass printing, the type of a mask to be applied for data thinning in the multipass printing, the amount of the inks to be applied to the print medium, and the printing direction. Further, examples of the control data necessary for the printing include driving conditions based on the temperatures in the print head 10 detected by the temperature sensors 46, the ink dot size, the print medium conveyance condition, the number of ink colors to be used, and the scanning speed of the print head 10 (carriage 20). Examples of the above driving conditions include the shape of a driving pulse to be applied to the printing elements, the duration of application of the driving pulse, and the like.

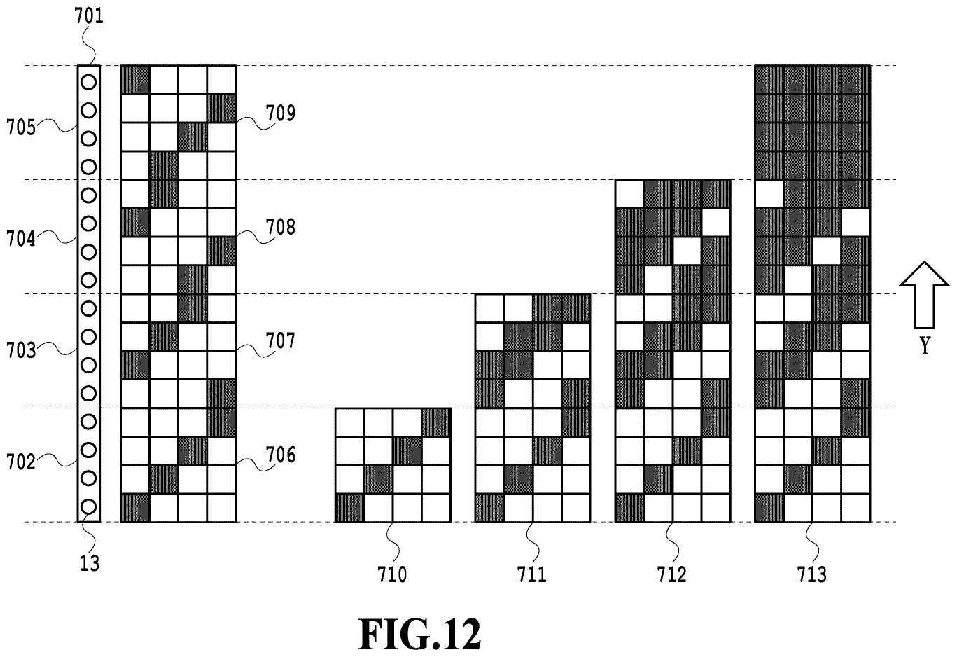

The printing apparatus 1 is capable of executing so-called multipass printing which prints an image on a unit region (1/n band) of a print medium by a plurality of (n) printing scans of the print head 10. FIG. 12 is an explanatory diagram illustrating a printing method by multipass printing. The printing apparatus 1 prints an image by a multipass printing method in which printing is performed on a unit region (predetermined region) of the print medium in a plurality of printing scans of the print head 10. With FIGS. 12, 4-pass multipass printing in which printing is performed in four printing scans will be described as an example. Also, for a simple description, an ejection port array 701 is illustrated as 16 ejection ports 13 for ejecting the same type of ink arranged in a single array.

In the case of performing 4-pass multipass printing, the 16 ejection ports 13 are divided into first to fourth ejection port regions 702 to 705 each including 4 ejection ports 13. The first ejection port region 702 is associated with a first mask pattern 706, and the second ejection port region 703 is associated with a second mask pattern 707. The third ejection port region 704 is associated with a third mask pattern 708, and the fourth ejection port region 705 is associated with a fourth mask pattern 709. Each mask pattern has a region with 4×4 areas. Each area illustrated in black represents an area where printing a dot is permitted, whereas each area illustrated in white represents an area where printing a dot is not permitted. Also, the first to fourth mask patterns 706 to 709 have such a relationship that they complement each other.

Patterns 710 to 713 illustrated in association with the first to fourth printing scans represent how an image becomes completed on a print medium in a case of performing 4-pass multipass printing in accordance with the first to fourth mask patterns 706 to 709. Each time a printing scan is finished, the print medium is conveyed by four pixels in the Y direction. The image in each unit region (4×4 pixel region) on the print medium is completed by four printing scans following the first to fourth mask patterns 706 to 709 having the complementary relationship.

### Method of Controlling Printing Apparatus

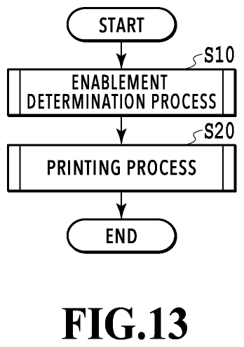

Next, a method of controlling the printing apparatus in the present embodiment will be described using FIG. 13. FIG. 13 is a flowchart illustrating the method of controlling the printing apparatus. Note that the steps in the flowchart illustrated in FIG. 13 are executed by the MPU 602 executing a control program stored in the control ROM 605 of the controller 600 as a computer.

In a case where a print information signal containing print data is transferred to the MPU 602 from the PPI 601, the MPU 602 performs an enablement determination process in step S10. The enablement determination process is followed by step S20, in which the MPU 602 performs a printing process. The enablement determination process and the printing process will be described later.

### Enablement Determination Process

Next, the enablement determination process in the present embodiment will be described. The enablement determination process is performed in the period from the transfer of the print information signal containing print data to the MPU 602 from the PPI 601 to the start of the printing process. In the enablement determination process, the MPU 602 determines whether to perform the standby control in the printing process based on the number of passes to be repeated in the multipass printing, the amount of the inks to be applied to the print medium, and the scanning speed of the print head 10 (carriage 20). Note that the number of passes to be repeated in the multipass printing, the amount of the inks to be applied to the print medium, and the scanning speed of the print head 10 (carriage 20) are set based on the predetermined command attached to the head of the print data transferred to the MPU 602. The number of passes to be repeated in the multipass printing represents the number of printing scans of the print head 10 to be performed in the multipass printing.

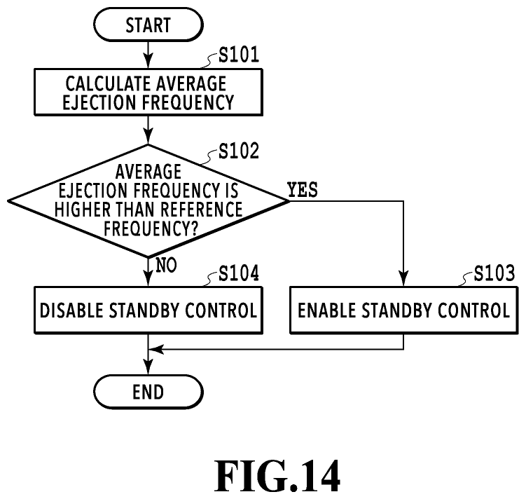

FIG. 14 is a flowchart illustrating the enablement determination process in the first embodiment. In step S101, the MPU 602 of the controller 600 calculates the average ejection frequency per printing scan of the print head 10. At this time, the MPU 602 calculates the average ejection frequency per printing scan of the print head 10 based on the number of passes to be repeated in the multipass printing, the maximum value of the amount of the inks to be applied to the print medium, and the scanning speed of the print head 10 (carriage 20).

Here, the number of passes to be repeated in the multipass printing is denoted as SC, the maximum value of the amount of the inks to be applied to the print medium is denoted as PT, and the scanning speed of the print head 10 (carriage 20) is denoted as VC. The number of ejection port arrays in the print head 10 is denoted as CM, and the average ejection frequency per printing scan of the print head 10 is denoted as FR. Note that the amount of the inks to be applied to the print medium represents the ratio of the number of ink dots to be printed on the print medium. The amount of the inks to be applied to the print medium may also be referred to as the printing density per unit region. In the present embodiment, the printing apparatus 1 has a printing resolution of 1200 dpi (dots per inch)×1200 dpi. A state where a single dot is printed on each individual unit region measuring 1200 dpi×1200 dpi is considered a state where the amount of ink application to the print medium is 100%. In this case, the average ejection frequency per printing scan of the print head 10 is represented by Equation (1) below.

$$FR = VC \times 1200 \times ( PT / CM ) / SC \qquad ( 1 )$$

For example, two ejection port arrays are assumed to be arranged per color (i.e., CM=2) along the main scanning direction (X direction) in the print head 10. The number of passes to be repeated in the multipass printing is assumed to be six (i.e., SC=6). The maximum value of the amount of the inks to be applied to the print medium is 175% (i.e., PT=1.75). The scanning speed of the print head 10 (carriage 20) is assumed to be 60 inches per second (ips) (i.e., VC=60). In this case, the average ejection frequency per printing scan of the print head 10 is 60 (ips)×1200 (dpi)×(1.75/2)/6=10.5 (kHz).

In step S102, the MPU 602 determines whether the average ejection frequency per printing scan of the print head 10 is higher than a predetermined reference frequency. To achieve high-speed image printing or high-resolution image printing, the print head 10 in which a plurality of ejection ports (printing elements) are densely disposed needs to be driven at a high frequency, in which case the print head 10 will easily reach a temperature during the printing at or above which it will be determined to be in an overheated state. The predetermined reference frequency is a frequency that serves as a criterion for determining whether to perform the standby control, and is set to 10.5 kHz, for example. If the average ejection frequency per printing scan of the print head 10 is higher than the predetermined reference frequency, that is, the determination in step S102 is YES, the MPU 602 proceeds to step S103. If the average ejection frequency per printing scan of the print head 10 is the predetermined reference frequency or lower, that is, the determination in step S102 is NO, the MPU 602 proceeds to step S104.

In step S103, the MPU 602 enables the standby control in the printing process to be described later, and terminates the process. In this way, the MPU 602 determines to perform the standby control in a case where the average ejection frequency per printing scan of the print head 10 is higher than the predetermined reference frequency.

In step S104, the MPU 602 disables the standby control in the printing process to be described later, and terminates the process. In this way, the MPU 602 determines not to perform the standby control in a case where the average ejection frequency per printing scan of the print head 10 is the predetermined reference frequency or lower.

### Printing Process

Next, the printing process in the present embodiment will be described. In the printing process, the MPU 602 of the controller 600 performs standby control by which the print head 10 is caused to stand by for a standby time in a case where the temperature detected by the temperature sensors 46 is higher than a standby temperature. This allow the printing to be performed within a temperature range within which ejection failure or the like does not occur. The standby control is similar to the temperature rise suppression control described earlier, and enables the print head to avoid falling into an overheated state while preventing density unevenness and hue unevenness in the image.

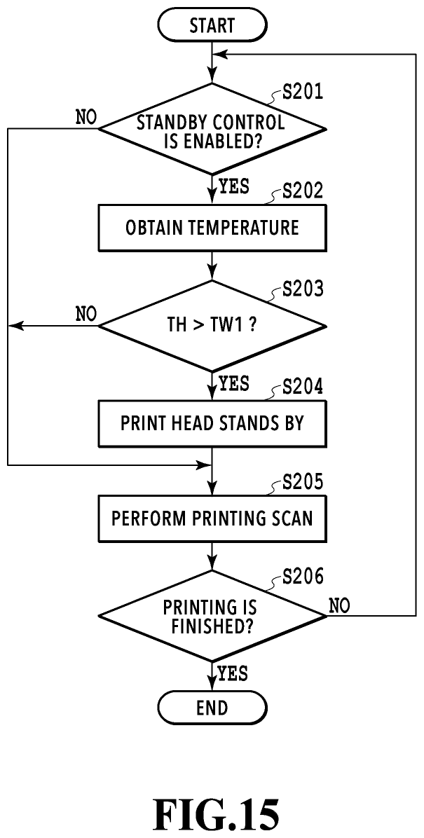

FIG. 15 is a flowchart illustrating the printing process. After performing the enablement determination process, in step S201, the MPU 602 determines whether the standby control is enabled. If the standby control is enabled, that is, the determination in step S201 is YES, the MPU 602 proceeds to step S202. If the standby control is disabled, that is, the determination in step S201 is NO, the MPU 602 proceeds to step S205.

In step S202, the MPU 602 obtains the temperature of the print head 10 based on the temperature detection signals input from the temperature sensors 46. Hereinafter, the temperature of the print head 10 detected by the temperature sensors 46 will be referred to as “head temperature TH.”

In step S203, the MPU 602 determines whether the head temperature TH is higher than a standby temperature TW1. At this time, the MPU 602 compares the obtained head temperature TH and the standby temperature TW1 stored in the control ROM 605 with each other. If the head temperature TH is higher than the standby temperature TW1, that is, the determination is step S203 is YES, the MPU 602 proceeds to step S204. If the head temperature TH is the standby temperature TW1 or lower, that is, the determination is step S203 is NO, the MPU 602 proceeds to step S205.

Note that the standby temperature TW1 is set to such a temperature that it is determined to be desirable to temporarily stop the printing scan of the print head 10 in advance in order to prevent the head temperature TH from rising to a temperature at or above which ejection failure or the like will occur. In the present embodiment, the standby temperature TW1 is set to 51° C., for example.

In step S204, the MPU 602 causes the print head 10 to stand by for a standby time before the print head 10 performs a printing scan. At this time, the MPU 602 sets a standby time for which the print head 10 (and the carriage 20) will be caused to stand by to prevent density unevenness and hue unevenness, and causes the print head 10 to stand by for the set standby time. The standby time that prevents density unevenness and hue unevenness is set to 0.3 seconds, for example.

Incidentally, in step S204, the MPU 602 may set the number of printing scans for which the print head 10 will be caused to stand by in addition to the standby time. Also, the MPU 602 may vary the number of printing scans for which the print head 10 will be caused to stand by according to the head temperature TH. The MPU 602 may vary the standby time according to the head temperature TH.

In step S205, the MPU 602 causes the print head 10 (and the carriage 20) to perform a single printing scan. At this time, a printing scan in which the print head 10 prints at least part of the image while moving in the main scanning direction and a conveyance operation in which the upstream conveyance rollers 25 and 26 and the downstream conveyance rollers 27 and 28 (conveyance motor 633) convey the print medium P are alternately performed one time each.

In step S206, the MPU 602 determines whether the printing of the image has been finished. Note that in a case where the print data transferred to the MPU 602 is print data on printing of images of a plurality of pages, the MPU 602 determines whether the printing of the images of all pages has been finished. If the printing of the image has not been finished, that is, the determination in step S206 is NO, the MPU 602 returns to step S201. If the printing of the image has been finished, that is, the determination in step S206 is YES, the process ends.

In a case where the MPU 602 enables the standby control in the above-described enablement determination process, all of the processes of steps S201 to S206 in the printing process are executed. On the other hand, in a case where the MPU 602 disables the standby control in the above-described enablement determination process, the processes of steps S202 to S204 in the printing process are skipped. In a case where the average ejection frequency per printing scan of the print head 10 is the predetermined reference frequency or lower, the amount of heat accumulated in the print head 10 is relatively small. Hence, the print head 10 will not fall into an overheated state during the printing. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

### Modification of Printing Process

Next, a modification of the printing process will be described. In the modification of the printing process, in a case where the head temperature is higher than the standby start temperature, the MPU 602 of the controller 600 performs temperature lowering control which causes the print head 10 to stand by until the head temperature becomes lower than the standby end temperature. Note that the standby start temperature is a temperature at or above which the print head 10 will be determined to be in an overheated state. The standby end temperature is a temperature at or below which ejection failure or the like is unlikely to occur.

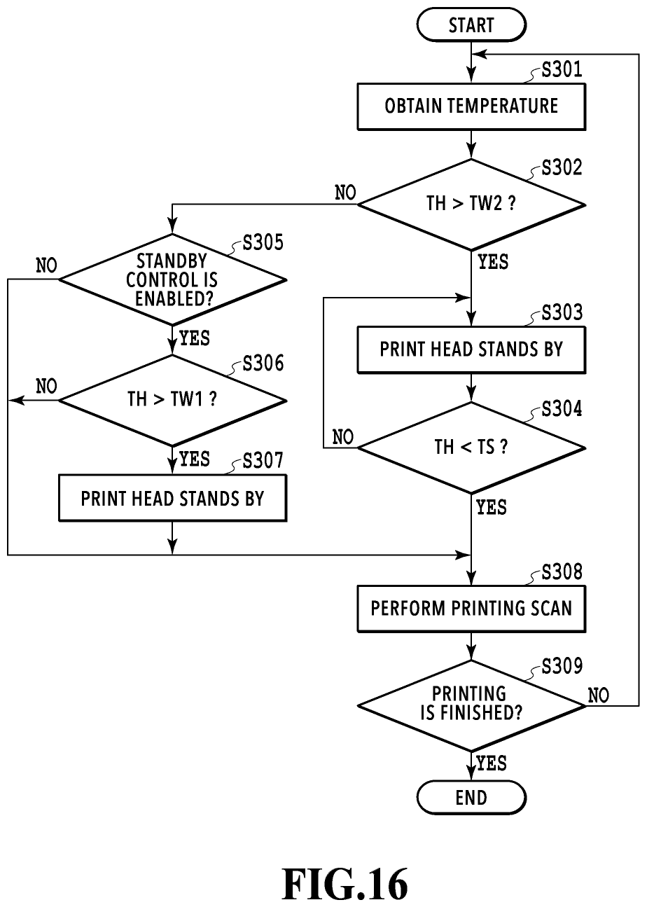

FIG. 16 is a flowchart illustrating the modification of the printing process. After performing the enablement determination process, in step S301, the MPU 602 obtains the head temperature TH based on the temperature detection signals input from the temperature sensors 46.

In step S302, the MPU 602 determines whether the head temperature TH is higher than a standby start temperature TW2. At this time, the MPU 602 compares the obtained head temperature TH and the standby start temperature TW2 stored in the control ROM 605 with each other. If the head temperature TH is higher than the standby start temperature TW2, that is, the determination is step S302 is YES, the MPU 602 proceeds to step S303. If the head temperature TH is the standby start temperature TW2 or lower, that is, the determination is step S302 is NO, the MPU 602 proceeds to step S305.

Note that the standby start temperature TW2 is set to a temperature at or above which the print head 10 will be determined to be in an overheated state, in other words, a temperature at or above which ejection failure or the like is likely to occur. In the present modification, the standby start temperature TW2 is set to 60° C., for example. The standby temperature TW1 mentioned earlier is set to a lower temperature than the standby start temperature TW2.

In step S303, the MPU 602 causes the print head 10 to stand by before the print head 10 performs a printing scan. Also, at this time, the MPU 602 obtains the head temperature TH based on the temperature detection signals input from the temperature sensors 46. As the print head 10 stands by, the head temperature TH drops.

In the next step S304, the MPU 602 determines whether the head temperature TH has become lower than a standby end temperature TS. At this time, the MPU 602 compares the obtained head temperature TH and the standby end temperature TS stored in the control ROM 605 with each other. If the head temperature TH has become lower than the standby end temperature TS, that is, the determination in step S304 is YES, the MPU 602 terminates the temperature lowering control for causing the print head 10 to stand by, and proceeds to step S308. If the head temperature TH is the standby end temperature TS or higher, that is, the determination is step S304 is NO, the MPU 602 returns to step S303.

Note that the standby end temperature TS is a lower temperature than the standby start temperature TW2, and is set to a temperature at or below which ejection failure or the like is unlikely to occur. In the present modification, the standby end temperature TS is set to 51° C., for example. The standby end temperature TS may be set to a lower temperature than the standby temperature TW1 mentioned earlier.

In step S305, the MPU 602 determines whether the standby control is enabled. If the standby control is enabled, that is, the determination in step S305 is YES, the MPU 602 proceeds to step S306. If the standby control is disabled, that is, the determination in step S305 is NO, the MPU 602 proceeds to step S308.

In step S306, the MPU 602 determines whether the head temperature TH is higher than the standby temperature TW1. At this time, the MPU 602 compares the obtained head temperature TH and the standby temperature TW1 stored in the control ROM 605 with each other. If the head temperature TH is higher than the standby temperature TW1, that is, the determination is step S306 is YES, the MPU 602 proceeds to step S307. If the head temperature TH is the standby temperature TW1 or lower, that is, the determination is step S306 is NO, the MPU 602 proceeds to step S308.

In step S307, the MPU 602 causes the print head 10 to stand by for a standby time before the print head 10 performs a printing scan, and proceeds to step S308. Note that the standby temperature TW1 and the standby time are set similarly to those in the printing process described earlier. In most cases, the standby time for the print head 10 in the standby control is shorter than the time required for the head temperature TH having exceeded the standby start temperature TW2 to drop to the standby end temperature TS.

Incidentally, in step S307, the MPU 602 may set the number of printing scans for which the print head 10 will be caused to stand by in addition to the standby time. Also, the MPU 602 may vary the number of printing scans for which the print head 10 will be caused to stand by according to the head temperature TH. The MPU 602 may vary the standby time according to the head temperature TH.

In step S308, the MPU 602 causes the print head 10 (and the carriage 20) to perform a single printing scan. At this time, a printing scan in which the print head 10 prints at least part of the image while moving in the main scanning direction and a conveyance operation in which the upstream conveyance rollers 25 and 26 and the downstream conveyance rollers 27 and 28 (conveyance motor 633) convey the print medium P are alternately performed one time each.

In step S309, the MPU 602 determines whether the printing of the image has been finished. Note that in a case where the print data transferred to the MPU 602 is print data on printing of images of a plurality of pages, the MPU 602 determines whether the printing of the images of all pages has been finished. If the printing of the image has not been finished, that is, the determination in step S309 is NO, the MPU 602 returns to step S301. If the printing of the image has been finished, that is, the determination in step S309 is YES, the process ends.

In a case where the MPU 602 enables the standby control in the above-described enablement determination process, all of the processes of steps S301 to S309 in the printing process in the modification are executed. On the other hand, in a case where the MPU 602 disables the standby control in the above-described enablement determination process, the processes of steps S306 and S307 in the printing process in the modification are skipped. In a case of performing printing based on print data with which the print head 10 is designed not to fall into an overheated state, the standby control is not performed, as with the printing process described earlier. This can reduce the occurrence of an unnecessary standby time. Therefore, it is possible to reduce the decrease in the throughput of the printing apparatus.

In the modification of the printing process, step S305 described above may be set before step S301 described above, i.e., at the beginning of the printing process. In this case, the MPU 602 proceeds to step S301 described above if the standby control is enabled, and proceeds to step S308 described above if the standby control is disabled. In this way, steps S301 to S304 described above will be skipped in addition to step S306 and S307 described above in a case where the standby control is disabled. Hence, the MPU 602 can determine whether to perform the standby control and the temperature lowering control based on the print data (or the environmental temperature data to be described later) in the above-described enablement determination process.

As described above, according to the first embodiment, it is possible to reduce the decrease in the throughput of the printing apparatus. Specifically, in the present embodiment, the MPU 602 of the controller 600 determines whether to perform the standby control based on print data (print information) for printing an image on a print medium with the print head 10. For example, the MPU 602 determines to perform the standby control in a case where the average ejection frequency per printing scan of the print head 10 is higher than the predetermined reference frequency. On the other hand, the MPU 602 determines not to perform the standby control in a case where the average ejection frequency per printing scan of the print head 10 is the predetermined reference frequency or lower. In the case where the average ejection frequency per printing scan of the print head 10 is the predetermined reference frequency or lower, the amount of heat accumulated in the print head 10 is relatively small. Hence, the print head 10 will not fall into an overheated state during the printing. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

### Second Embodiment

Next, a second embodiment will be described. Each individual member in the second embodiment has a similar configuration to that in the above first embodiment. Thus, the description will be given with these members denoted by the same reference signs as those in the above first embodiment. The printing apparatus according to the second embodiment is configured similarly to the printing apparatus 1 according to the first embodiment.

### Enablement Determination Process

An enablement determination process in the second embodiment will now be described. As in the first embodiment, the enablement determination process is performed in the period from transfer of a print information signal containing print data to the MPU 602 from the PPI 601 to the start of a printing process. In the first embodiment, the MPU 602 determines whether to perform standby control in the printing process based on the average ejection frequency per printing scan of the print head 10. In the second embodiment, the MPU 602 determines whether to perform standby control in the printing process based on the heating temperature for heating a gas with the air blow unit 300.

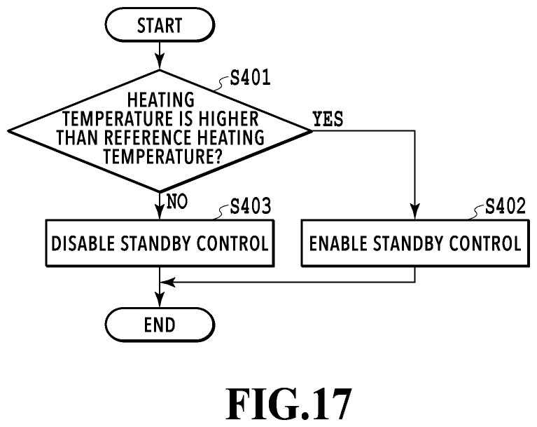

FIG. 17 is a flowchart illustrating the enablement determination process in the second embodiment. In step S401, the MPU 602 of the controller 600 determines whether the heating temperature for heating the gas with the air blow unit 300 is higher than a predetermined reference heating temperature. Note that the heating temperature for heating the gas with the air blow unit 300 is set based the predetermined command attached to the head of the print data transferred to the MPU 602. If the temperature of the gas sent from the air blow unit 300 is high, the inside of the printing apparatus 1 and the print head 10 get heated and the print head 10 is likely to reach a temperature during the printing at or above which it will be determined to be in an overheated state. The predetermined reference heating temperature is a heating temperature that serves as a criterion for determining whether to perform the standby control, and is set to 35° C., for example. If the heating temperature for heating the gas with the air blow unit 300 is higher than the predetermined reference heating temperature, that is, the determination in step S401 is YES, the MPU 602 proceeds to step S402. If the heating temperature for heating the gas with the air blow unit 300 is the predetermined reference heating temperature or lower, that is, the determination in step S401 is NO, the MPU 602 proceeds to step S403.

In step S402, the MPU 602 enables the standby control in the printing process, and terminates the process. In this way, the MPU 602 determines to perform the standby control in a case where the heating temperature for heating the gas with the air blow unit 300 is higher than the predetermined reference heating temperature.

In step S403, the MPU 602 disables the standby control in the printing process, and terminates the process. In this way, the MPU 602 determines not to perform the standby control in a case where the heating temperature for heating the gas with the air blow unit 300 is the predetermined reference heating temperature or lower.

In a case where the MPU 602 enables the standby control in the enablement determination process in the second embodiment, all of the processes of steps S201 to S206 in the printing process illustrated in the flowchart of FIG. 15 are executed, as in the first embodiment. On the other hand, in a case where the MPU 602 disables the standby control in the enablement determination process in the second embodiment, the processes of steps S202 to S204 in the printing process illustrated in the flowchart of FIG. 15 are skipped, as in the first embodiment. In a case where the heating temperature for heating the gas with the air blow unit 300 is the predetermined reference heating temperature or lower, the amount of heat accumulated in the print head 10 is relatively small. Hence, the print head 10 performing the printing will not fall into an overheated state. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

Also, in the second embodiment, the printing process illustrated in the flowchart of FIG. 16 may be performed instead of the printing process illustrated in the flowchart of FIG. 15. As in the modification of the printing process in the first embodiment, this can reduce the occurrence of an unnecessary standby time, and accordingly reduce the decrease in the throughput of the printing apparatus which would otherwise occur.

As described above, according to the second embodiment, it is possible to reduce the decrease in the throughput of the printing apparatus. Specifically, in the present embodiment, the MPU 602 of the controller 600 determines whether to perform the standby control based on print data (print information) for printing an image on a print medium with the print head 10. For example, the MPU 602 determines to perform the standby control in a case where the heating temperature for heating the gas with the air blow unit 300 is higher than the predetermined reference heating temperature. On the other hand, the MPU 602 determines not to perform the standby control in a case where the heating temperature for heating the gas with the air blow unit 300 is the predetermined reference heating temperature or lower. In a case where the heating temperature for heating the gas with the air blow unit 300 is the predetermined reference heating temperature or lower, the amount of heat accumulated in the print head 10 is relatively small. Hence, the print head 10 performing the printing will not fall into an overheated state. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

### Third Embodiment

Next, a third embodiment will be described. Each individual member in the third embodiment has a similar configuration to that in the above first embodiment. Thus, the description will be given with these members denoted by the same reference signs as those in the above first embodiment. The printing apparatus according to the third embodiment is configured similarly to the printing apparatus 1 according to the first embodiment.

### Enablement Determination Process

An enablement determination process in the third embodiment will now be described. As in the first embodiment, the enablement determination process is performed in the period from transfer of a print information signal containing print data to the MPU 602 from the PPI 601 to the start of a printing process. In the third embodiment, the MPU 602 determines whether to perform standby control in the printing process based on the fixing temperature for heating a gas with the fixing unit 350.

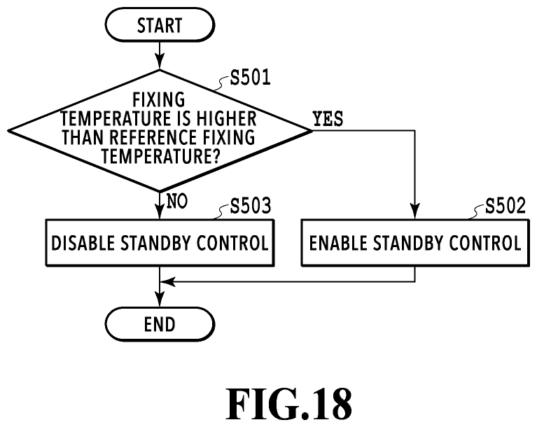

FIG. 18 is a flowchart illustrating the enablement determination process in the third embodiment. In step S501, the MPU 602 of the controller 600 determines whether the fixing temperature for fixing the inks with the fixing unit 350 is higher than a predetermined reference fixing temperature. Note that the fixing temperature for fixing the inks with the fixing unit 350 is set based the predetermined command attached to the head of the print data transferred to the MPU 602. If the temperature of the gas blown by the fixing unit 350 is high, the inside of the printing apparatus 1 and the print head 10 get heated and, during the printing, the print head 10 is likely to reach a temperature at or above which it will be determined to be in an overheated state. The predetermined reference fixing temperature is a fixing temperature that serves as a criterion for determining whether to perform the standby control, and is set to 80° C., for example. If the fixing temperature for fixing the inks with the fixing unit 350 is higher than the predetermined reference fixing temperature, that is, the determination in step S501 is YES, the MPU 602 proceeds to step S502. If the fixing temperature for fixing the inks with the fixing unit 350 is the predetermined reference fixing temperature or lower, that is, the determination in step S501 is NO, the MPU 602 proceeds to step S503.

In step S502, the MPU 602 enables the standby control in the printing process, and terminates the process. In this way, the MPU 602 determines to perform the standby control in a case where the fixing temperature for fixing the inks with the fixing unit 350 is higher than the predetermined reference fixing temperature.

In step S503, the MPU 602 disables the standby control in the printing process, and terminates the process. In this way, the MPU 602 determines not to perform the standby control in a case where the fixing temperature for fixing the inks with the fixing unit 350 is the predetermined reference fixing temperature or lower.

In a case where the MPU 602 enables the standby control in the enablement determination process in the third embodiment, all of the processes of steps S201 to S206 in the printing process illustrated in the flowchart of FIG. 15 are executed, as in the first embodiment. On the other hand, in a case where the MPU 602 disables the standby control in the enablement determination process in the third embodiment, the processes of steps S202 to S204 in the printing process illustrated in the flowchart of FIG. 15 are skipped, as in the first embodiment. In a case where the fixing temperature for fixing the inks with the fixing unit 350 is the predetermined reference fixing temperature or lower, the amount of heat accumulated in the print head 10 is relatively small. Hence, the print head 10 performing the printing will not fall into an overheated state. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

Also, in the third embodiment, the printing process illustrated in the flowchart of FIG. 16 may be performed instead of the printing process illustrated in the flowchart of FIG. 15. As in the modification of the printing process in the first embodiment, this can reduce the occurrence of an unnecessary standby time, and accordingly reduce the decrease in the throughput of the printing apparatus which would otherwise occur.

As described above, according to the third embodiment, it is possible to reduce the decrease in the throughput of the printing apparatus. Specifically, in the present embodiment, the MPU 602 of the controller 600 determines whether to perform the standby control based on print data (print information) for printing an image on a print medium with the print head 10. For example, the MPU 602 determines to perform the standby control in a case where the fixing temperature for fixing the inks with the fixing unit 350 is higher than the predetermined reference fixing temperature. On the other hand, the MPU 602 determines not to perform the standby control in a case where the fixing temperature for fixing the inks with the fixing unit 350 is the predetermined reference fixing temperature or lower. In a case where the fixing temperature for fixing the inks with the fixing unit 350 is the predetermined reference fixing temperature or lower, the amount of heat accumulated in the print head 10 is relatively small. Hence, the print head 10 performing the printing will not fall into an overheated state. In a case of performing printing based on print data with which the print head 10 is designed not to fall into an overheated state, the standby control is not performed. This can reduce the occurrence of an unnecessary standby time. Therefore, it is possible to reduce the decrease in the throughput of the printing apparatus.

### Fourth Embodiment

Next, a fourth embodiment will be described. Each individual member in the fourth embodiment has a similar configuration to that in the above first embodiment. Thus, the description will be given with these members denoted by the same reference signs as those in the above first embodiment. The printing apparatus according to the fourth embodiment is configured similarly to the printing apparatus 1 according to the first embodiment.

### Enablement Determination Process

An enablement determination process in the fourth embodiment will now be described. As in the first embodiment, the enablement determination process is performed in the period from transfer of a print information signal containing print data to the MPU 602 from the PPI 601 to the start of a printing process. In the fourth embodiment, the MPU 602 determines whether to perform standby control in the printing process based on a temperature detection signal input from the temperature-humidity sensor 622, i.e., environmental temperature data.

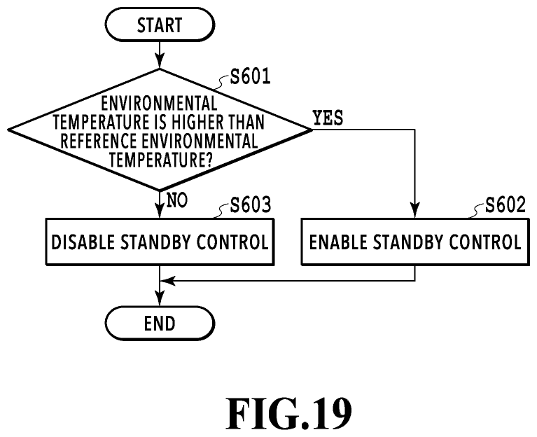

FIG. 19 is a flowchart illustrating the enablement determination process in the fourth embodiment. In step S601, the MPU 602 of the controller 600 determines whether the environmental temperature obtained using the temperature-humidity sensor 622 is higher than a predetermined reference environmental temperature. The higher the environmental temperature, the higher the temperature of the print head 10 while performing no printing, and the more likely the print head 10 will reach a temperature during printing at or above which it will be determined to be in an overheated state. The predetermined reference environmental temperature is an environmental temperature that serves as a criterion for determining whether to perform the standby control, and is set to 30° C., for example. If the environmental temperature is higher than the predetermined reference environmental temperature, that is, the determination in step S601 is YES, the MPU 602 proceeds to step S602. If the environmental temperature is the predetermined reference environmental temperature or lower, that is, the determination in step S601 is NO, the MPU 602 proceeds to step S603.

In step S602, the MPU 602 enables the standby control in the printing process, and terminates the process. In this way, the MPU 602 determines to perform the standby control in a case where the environmental temperature is higher than the predetermined reference environmental temperature.

In step S603, the MPU 602 disables the standby control in the printing process, and terminates the process. In this way, the MPU 602 determines not to perform the standby control in a case where the environmental temperature is the predetermined reference environmental temperature or lower.

In a case where the MPU 602 enables the standby control in the enablement determination process in the fourth embodiment, all of the processes of steps S201 to S206 in the printing process illustrated in the flowchart of FIG. 15 are executed, as in the first embodiment. On the other hand, in a case where the MPU 602 disables the standby control in the enablement determination process in the fourth embodiment, the processes of steps S202 to S204 in the printing process illustrated in the flowchart of FIG. 15 are skipped, as in the first embodiment. In a case where the environmental temperature is the predetermined reference environmental temperature or lower, the amount of heat accumulated in the print head 10 is relatively small. Hence, the print head 10 performing the printing will not fall into an overheated state. In a case of performing printing at an environmental temperature at which the print head 10 is designed not to fall into an overheated state, the standby control is not performed. This can reduce the occurrence of an unnecessary standby time. Therefore, it is possible to reduce the decrease in the throughput of the printing apparatus.

Also, in the fourth embodiment, the printing process illustrated in the flowchart of FIG. 16 may be performed instead of the printing process illustrated in the flowchart of FIG. 15. As in the modification of the printing process in the first embodiment, this can reduce the occurrence of an unnecessary standby time, and accordingly reduce the decrease in the throughput of the printing apparatus which would otherwise occur.

As described above, according to the fourth embodiment, it is possible to reduce the decrease in the throughput of the printing apparatus. Specifically, in the present embodiment, the MPU 602 of the controller 600 determines whether to perform the standby control based on environmental temperature data (environmental temperature information). For example, the MPU 602 determines to perform the standby control in a case where the environmental temperature is higher than the predetermined reference environmental temperature. On the other hand, the MPU 602 determines not to perform the standby control in a case where the environmental temperature is the predetermined reference environmental temperature or lower. In a case where the environmental temperature is the predetermined reference environmental temperature or lower, the amount of heat accumulated in the print head 10 is relatively small. Hence, the print head 10 performing the printing will not fall into an overheated state. In a case of performing printing at an environmental temperature at which the print head 10 is designed not to fall into an overheated state, the standby control is not performed. This can reduce the occurrence of an unnecessary standby time. Therefore, it is possible to reduce the decrease in the throughput of the printing apparatus.

### Fifth Embodiment

Next, a fifth embodiment will be described. Each individual member in the fifth embodiment has a similar configuration to that in the above first embodiment. Thus, the description will be given with these members denoted by the same reference signs as those in the above first embodiment. The printing apparatus according to the fifth embodiment is configured similarly to the printing apparatus 1 according to the first embodiment.

### Enablement Determination Process

An enablement determination process in the fifth embodiment will now be described. As in the first embodiment, the enablement determination process is performed in the period from transfer of a print information signal containing print data to the MPU 602 from the PPI 601 to the start of a printing process. In the fifth embodiment, the MPU 602 combines the enablement determination processes in the first to fourth embodiments to determine whether to perform standby control in the printing process. In this way, it is possible to accurately determine whether to perform the standby control in the printing process.

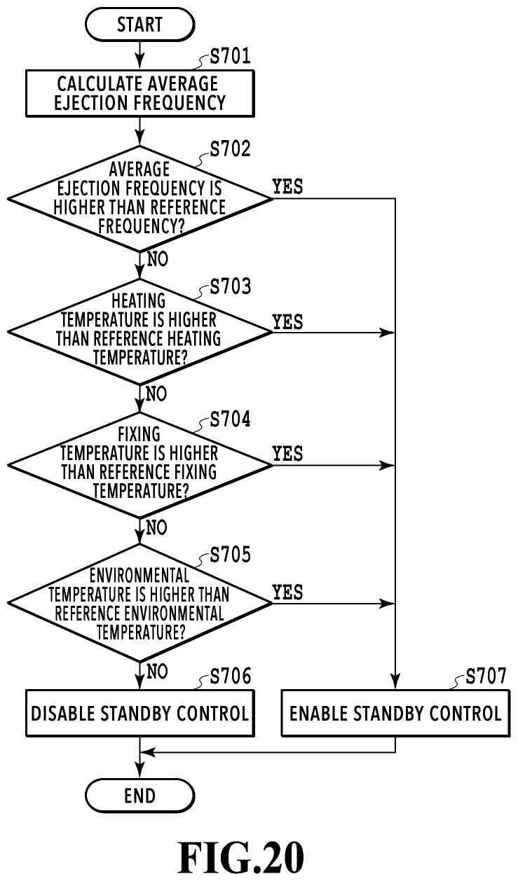

FIG. 20 is a flowchart illustrating the enablement determination process in the fifth embodiment. In step S701, as in the first embodiment, the MPU 602 of the controller 600 calculates the average ejection frequency per printing scan of the print head 10.

In step S702, as in the first embodiment, the MPU 602 determines whether the average ejection frequency per printing scan of the print head 10 is higher than a predetermined reference frequency. If the average ejection frequency per printing scan of the print head 10 is the predetermined reference frequency or lower, that is, the determination in step S702 is NO, the MPU 602 proceeds to step S703. If the average ejection frequency per printing scan of the print head 10 is higher than the predetermined reference frequency, that is, the determination in step S702 is YES, the MPU 602 proceeds to step S707.

In step S703, as in the second embodiment, the MPU 602 determines whether the heating temperature for heating a gas with the air blow unit 300 is higher than a predetermined reference heating temperature. If the heating temperature for heating the gas with the air blow unit 300 is the predetermined reference heating temperature or lower, that is, the determination in step S703 is NO, the MPU 602 proceeds to step S704. If the heating temperature for heating the gas with the air blow unit 300 is higher than the predetermined reference heating temperature, that is, the determination in step S703 is YES, the MPU 602 proceeds to step S707.

In step S704, as in the third embodiment, the MPU 602 determines whether the fixing temperature for fixing the inks with the fixing unit 350 is higher than a predetermined reference fixing temperature. If the fixing temperature for fixing the inks with the fixing unit 350 is the predetermined reference fixing temperature or lower, that is, the determination in step S704 is NO, the MPU 602 proceeds to step S705. If the fixing temperature for fixing the inks with the fixing unit 350 is higher than the predetermined reference fixing temperature, that is, the determination in step S704 is YES, the MPU 602 proceeds to step S707.

In step S705, as in the fourth embodiment, the MPU 602 determines whether the environmental temperature obtained using the temperature-humidity sensor 622 is higher than a predetermined reference environmental temperature. If the environmental temperature is the predetermined reference environmental temperature or lower, that is, the determination in step S705 is NO, the MPU 602 proceeds to step S706. If the environmental temperature is higher than the predetermined reference environmental temperature, that is, the determination in step S705 is YES, the MPU 602 proceeds to step S707.

In step S706, the MPU 602 disables the standby control in the printing process, and terminates the process. The MPU 602 determines not to perform the standby control in a case where the average ejection frequency is the predetermined reference frequency or lower, the heating temperature is the predetermined reference heating temperature or lower, the fixing temperature is the predetermined reference fixing temperature or lower, and the environmental temperature is the predetermined reference environmental temperature or lower.

In step S707, the MPU 602 enables the standby control in the printing process, and terminates the process. In this way, the MPU 602 determines to perform the standby control in any of the following cases: a case where the average ejection frequency is higher than the predetermined reference frequency; a case where the heating temperature is higher than the predetermined reference heating temperature; and a case where the fixing temperature is higher than the predetermined reference fixing temperature. Also, the MPU 602 determines to perform the standby control in a case where the environmental temperature is higher than the predetermined reference environmental temperature.

In a case where the MPU 602 enables the standby control in the enablement determination process in the fifth embodiment, all of the processes of steps S201 to S206 in the printing process illustrated in the flowchart of FIG. 15 are executed, as in the first embodiment. On the other hand, in a case where the MPU 602 disables the standby control in the enablement determination process in the fifth embodiment, the processes of steps S202 to S204 in the printing process illustrated in the flowchart of FIG. 15 are skipped, as in the first embodiment.

According to the fifth embodiment, it is possible to reduce the decrease in the throughput of the printing apparatus, as in the first to fourth embodiments. Also, according to the fifth embodiment, it is possible to accurately determine whether to perform the standby control in the printing process by combining the enablement determination processes in the first to fourth embodiments.

In the fifth embodiment described above, the printing process illustrated in the flowchart of FIG. 16 may be performed instead of the printing process illustrated in the flowchart of FIG. 15. As in the modification of the printing process in the first embodiment, this can reduce the occurrence of an unnecessary standby time, and accordingly reduce the decrease in the throughput of the printing apparatus which would otherwise occur.

### Sixth Embodiment

Next, a sixth embodiment will be described. Each individual member in the sixth embodiment has a similar configuration to that in the above first embodiment. Thus, the description will be given with these members denoted by the same reference signs as those in the above first embodiment.

### Configuration of Printing Apparatus

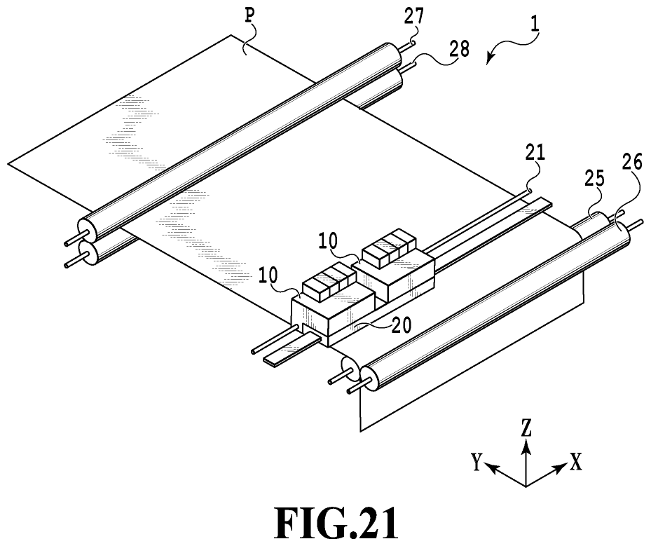

FIG. 21 is a perspective view illustrating a schematic configuration of a printing apparatus 1 according to the sixth embodiment. As illustrated in FIG. 21, the printing apparatus 1 according to the sixth embodiment is configured similarly to the printing apparatus 1 according to the first embodiment except that it includes two print heads 10. The two print heads 10 are mounted side by side in the main scanning direction (X direction) on a carriage 20.

### Enablement Determination Process

Next, an enablement determination process in the sixth embodiment will be described. As in the first embodiment, the enablement determination process is performed in the period from transfer of a print information signal containing print data to the MPU 602 from the PPI 601 to the start of a printing process. In the sixth embodiment, the MPU 602 determines whether to perform standby control in the printing process for each one of the plurality of print heads. In this way, it is possible to accurately determine whether to perform the standby control in the printing process. In the present embodiment, a number for identifying one of the plurality of print heads will be referred to as “head number N” (N is a natural number). For example, of the plurality of print heads, the first print head is expressed as “print head with head number 1,” the second print head is expressed as “print head with head number 2,” and the N-th print head is expressed as “print head with head number N.”

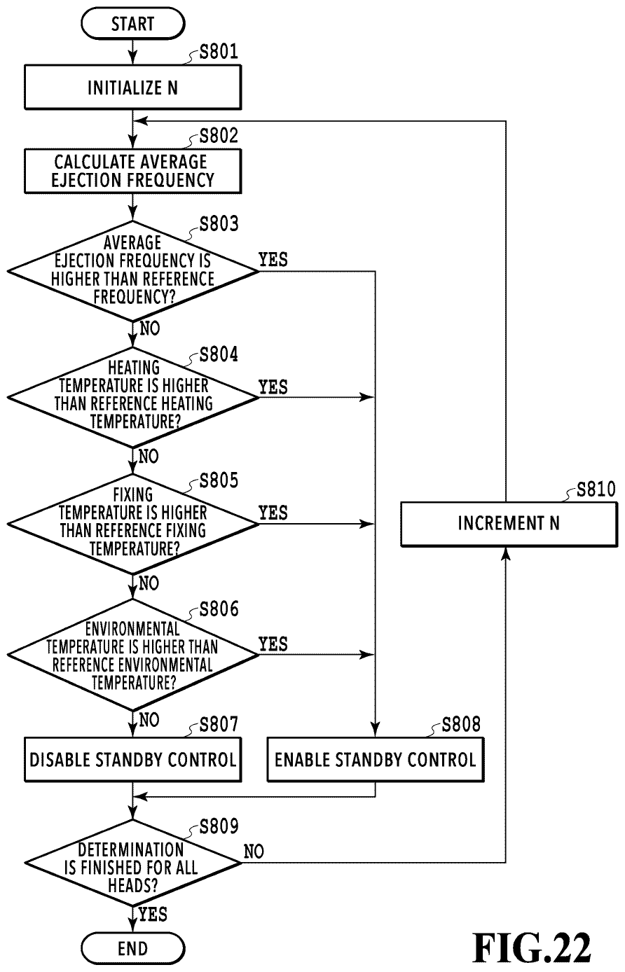

FIG. 22 is a flowchart illustrating the enablement determination process in the sixth embodiment. In step S801, the MPU 602 of the controller 600 initializes the head number N for identifying a print head. For example, the MPU 602 initializes the head number N to 1 (N=1).

In step S802, as in the first embodiment, the MPU 602 calculates the average ejection frequency per printing scan of the print head with the head number N. At this time, the MPU 602 calculates the average ejection frequency per printing scan of the print head with head number N based on the number of passes to be repeated, the maximum value of the amount of the inks to be applied to the print medium, and the scanning speed of the print head with head number N.

In step S803, as in the first embodiment, the MPU 602 determines whether the average ejection frequency per printing scan of the print head with head number N is higher than a predetermined reference frequency. If the average ejection frequency per printing scan of the print head with head number N is the predetermined reference frequency or lower, that is, the determination in step S803 is NO, the MPU 602 proceeds to step S804. If the average ejection frequency per printing scan of the print head with head number N is higher than the predetermined reference frequency, that is, the determination in step S803 is YES, the MPU 602 proceeds to step S808.

In step S804, as in the second embodiment, the MPU 602 determines whether the heating temperature for heating a gas with the air blow unit 300 is higher than a predetermined reference heating temperature. If the heating temperature for heating the gas with the air blow unit 300 is the predetermined reference heating temperature or lower, that is, the determination in step S804 is NO, the MPU 602 proceeds to step S805. If the heating temperature for heating the gas with the air blow unit 300 is higher than the predetermined reference heating temperature, that is, the determination in step S804 is YES, the MPU 602 proceeds to step S808.

In step S805, as in the third embodiment, the MPU 602 determines whether the fixing temperature for fixing the inks with the fixing unit 350 is higher than a predetermined reference fixing temperature. If the fixing temperature for fixing the inks with the fixing unit 350 is the predetermined reference fixing temperature or lower, that is, the determination in step S805 is NO, the MPU 602 proceeds to step S806. If the fixing temperature for fixing the inks with the fixing unit 350 is higher than the predetermined reference fixing temperature, that is, the determination in step S805 is YES, the MPU 602 proceeds to step S808.

In step S806, as in the fourth embodiment, the MPU 602 determines whether the environmental temperature obtained using the temperature-humidity sensor 622 is higher than a predetermined reference environmental temperature. If the environmental temperature is the predetermined reference environmental temperature or lower, that is, the determination in step S806 is NO, the MPU 602 proceeds to step S807. If the environmental temperature is higher than the predetermined reference environmental temperature, that is, the determination in step S806 is YES, the MPU 602 proceeds to step S808.

In step S807, the MPU 602 disables the standby control in the printing process, and terminates the process. The MPU 602 determines not to perform the standby control in a case where the average ejection frequency is the predetermined reference frequency or lower, the heating temperature is the predetermined reference heating temperature or lower, the fixing temperature is the predetermined reference fixing temperature or lower, and the environmental temperature is the predetermined reference environmental temperature or lower.

In step S808, the MPU 602 enables the standby control in the printing process, and terminates the process. In this way, the MPU 602 determines to perform the standby control in any of the following cases: a case where the average ejection frequency is higher than the predetermined reference frequency; a case where the heating temperature is higher than the predetermined reference heating temperature; and a case where the fixing temperature is higher than the predetermined reference fixing temperature. Also, the MPU 602 determines to perform the standby control in a case where the environmental temperature is higher than the predetermined reference environmental temperature.

In step S809, the MPU 602 determines whether the determination of whether to perform the standby control in the printing process has been finished for all print heads. If the determination of whether to perform the standby control in the printing process has not been finished, that is, the determination in step S809 is NO, the MPU 602 proceeds to step S810. In step S810, the MPU 602 performs an operation of incrementing the head number N, specifically, adding 1 to the head number N, and returns to step S802. On the other hand, if the determination of whether to perform the standby control in the printing process has been finished, that is, the determination in step S809 is YES, the process ends.

In a case where the MPU 602 enables the standby control for all print heads in the enablement determination process in the sixth embodiment, all of the processes of steps S201 to S206 in the printing process illustrated in the flowchart of FIG. 15 are executed, as in the first embodiment. On the other hand, in a case where the MPU 602 disables the standby control for all print heads in the enablement determination process in the sixth embodiment, the processes of steps S202 to S204 in the printing process illustrated in the flowchart of FIG. 15 are skipped, as in the first embodiment. In a case where the MPU 602 disables the standby control for one or more of the print heads in the enablement determination process in the sixth embodiment, the processes of steps S202 to S204 in the printing process illustrated in the flowchart of FIG. 15 are skipped for the one or more print heads. Note that the process of step S204 may be executed along with the print head or heads other than the one or more print heads (the print head or heads for which the standby control has been enabled), or skipped.

According to the sixth embodiment, it is possible to reduce the decrease in the throughput of the printing apparatus, as in the first to fourth embodiments. Also, according to the sixth embodiment, it is possible to accurately determine whether to perform the standby control in the printing process for each of the plurality of print heads by combining the enablement determination processes in the first to fourth embodiments.

In the sixth embodiment described above, the printing process illustrated in the flowchart of FIG. 16 may be performed instead of the printing process illustrated in the flowchart of FIG. 15. As in the modification of the printing process in the first embodiment, this can reduce the occurrence of an unnecessary standby time, and accordingly reduce the decrease in the throughput of the printing apparatus which would otherwise occur.

In the above sixth embodiment, the printing apparatus 1 includes two print heads 10, but the number of print heads is not limited to this. For example, the printing apparatus 1 may include three or more print heads.

In the above fifth and sixth embodiments, the MPU 602 combines the enablement determination processes in the first to fourth embodiments to determine whether to perform the standby control in the printing process, but the determination is not limited to this. For example, the MPU 602 may determine whether to perform the standby control in the printing process based on individual information on each print head 10 which is information on tolerances of the print head 10. Examples of the individual information on each print head 10 include information on the amount of the inks to be ejected by the print head 10, information on the size of the printing elements, information on the circulation flow rate of each ink to be circulated by the circulation pump 500.

In a case where the amount of the inks to be ejected from the print head 10 is small, the efficiency of heat dissipation in the print head 10 is low, and the temperature of the print head 10 will therefore rise easily. For this reason, the enablement determination process may additionally include a step of determining whether to perform the standby control in the printing process based on the amount of the inks to be ejected by the print head 10. Here, the MPU 602 may obtain the amount of the inks to be ejected by the print head 10 based on the diameter of the ejection ports 13 and the size of the printing elements stored in a ROM (not illustrated) of the print head 10. The MPU 602 may determine to perform the standby control in a case where the amount of the inks to be ejected by the print head 10 is smaller than a predetermined reference ejection amount. The MPU 602 may determine not to perform the standby control in a case where the amount of the inks to be ejected by the print head 10 is the predetermined reference ejection amount or more. The predetermined reference ejection amount is an ink ejection amount that serves as a criterion for determining whether to perform the standby control.

In a case where the size of the printing elements is large, the thermal energy to be generated by the printing elements is large, and the temperature of the print head 10 will therefore rise easily. For this reason, the enablement determination process may additionally include a step of determining whether to perform the standby control in the printing process based on the size of the printing elements. Here, the MPU 602 may determine to perform the standby control in a case where the size of the printing elements stored in the ROM of the print head 10 is larger than a predetermined reference size. The MPU 602 may determine not to perform the standby control in a case where the size of the printing elements is the predetermined reference size or smaller. The predetermined reference size is a size of a printing element that serves as a criterion for determining whether to perform the standby control. Note that the size of the printing elements may be the length of a printing element in a predetermined direction or the area of a printing element.

In a case where the circulation flow rate of each ink to be circulated by the circulation pump 500 is small, the ink will stagnate easily near the ejection ports 13 and the temperature of the print head 10 will therefore rise easily. For this reason, the enablement determination process may additionally include a step of determining whether to perform the standby control in the printing process based on the circulation flow rate of each ink to be circulated by the circulation pump 500. Here, the MPU 602 may obtain the circulation flow rate of each ink to be circulated by the circulation pump 500 based on the number of times to drive the circulation pump stored in the ROM of the print head 10. The MPU 602 may determine to perform the standby control in a case where the circulation flow rate of each ink to be circulated by the circulation pump 500 is lower than a predetermined reference flow rate. The MPU 602 may determine not to perform the standby control in a case where the circulation flow rate of each ink is the predetermined reference flow rate or higher. The predetermined reference flow rate is a circulation flow rate of each ink that serves as a criterion for determining whether to perform the standby control.

Also, as for the direction of printing scans of each print head 10, the print head 10 may perform printing only while moving in one direction (main scanning direction) or perform printing while moving reciprocally in two opposite directions. In a case where the user sets the direction of printing scans of each print head 10 to one direction, it is possible to lower the temperature of the print head 10 according to the time for which the print head 10 moves until the next printing after the previous printing. In this way, the print head 10 is unlikely to reach a temperature during the printing at or above which it will be determined to be in an overheated state. For this reason, the enablement determination process may additionally include a step of determining whether to perform the standby control in the printing process based on information on the direction of printing scans of the print head 10. Here, the MPU 602 may determine to perform the standby control in a case where the printing scans of the print head 10 are two-direction printing scans. The MPU 602 may determine not to perform the standby control in a case where the printing scans of the print head 10 are one-direction printing scans.

Also, in a case where ejection failure occurs at some of the ejection ports in any of the print heads 10, the frequency of ejection from the other ejection ports in the print head 10 may be increased in order to compensate for the decrease in the number of ink dots. In a case where the frequency of ejection from the other ejection ports in the print head 10 is increased, the temperature of the print head 10 will be likely to rise. For this reason, the enablement determination process may additionally include a step of determining whether to perform the standby control in the printing process based on information on ejection failure. Here, the MPU 602 may determine to perform the standby control in a case where ejection failure occurs at some of the ejection ports in any of the print heads 10. The MPU 602 may determine not to perform the standby control in a case where ejection failure has occurred in none of the ejection ports in any of the print heads 10.

Also, in order to prevent uneven drying in the fixing of the inks by the air blow unit 300 and the fixing unit 350, a certain fixing standby time may be set per printing scan of the print heads 10. The longer the fixing standby time, the more likely the temperature of the print head 10 will drop. For this reason, the enablement determination process may additionally include a step of determining whether to perform the standby control in the printing process based on information on the fixing standby time. Here, the MPU 602 may determine to perform the standby control in a case where no fixing standby time is set. The MPU 602 may determine not to perform the standby control in a case where a fixing standby time is set.

Also, in order to maintain the amount of ink ejection from each print head 10 constant, a driving pulse having a larger pulse energy than that of a normal driving pulse may be applied to printing elements that have deteriorated according to the total number of ink dots. In a case where the pulse energy of the driving pulse to be applied to the printing elements is increased, the temperature of the print head 10 will be likely to rise. For this reason, the enablement determination process may additionally include a step of determining whether to perform the standby control in the printing process based on the driving pulse to be applied to the printing elements. Here, the MPU 602 may determine to perform the standby control in a case where a driving pulse having a larger pulse energy than that of the normal driving pulse is applied to the printing elements. The MPU 602 may determine not to perform the standby control in a case where the normal driving pulse is applied to the printing elements.

In the above fourth to sixth embodiments, the MPU 602 determines whether to perform the standby control in the printing process based on the temperature detection signal input from the temperature-humidity sensor 622, i.e., environmental temperature data (environmental temperature information), but the determination is not limited to this. For example, in a case where the printing apparatus 1 is not provided with the temperature-humidity sensor 622, the MPU 602 may determine whether to perform the standby control in the printing process based on environmental temperature data (temperature detection signal) input from the sensors 652 provided outside the printing apparatus 1. In this case, the sensors 652 may include a temperature-humidity sensor, for example.

In each of the above embodiments, the circulation pump 500 is a piezoelectric pump that is driven in response to application of a voltage to its piezoceramic member, but is not limited to this. For example, the circulation pump may be a tube pump that causes rollers to revolve and push out a liquid sucked into a tube to deliver the liquid.

In each of the above embodiments, the or each print head 10 includes circulation units 54 each having the circulation pump 500 but is not limited to this. For example, the circulation pump 500 may be provided to be separate from the print head 10 (circulation unit 54). Also, the print head 10 does not need to be provided with the circulation units 54.

In each of the above embodiments, the air blow unit 300 and the fixing unit 350 are provided, but the configuration is not limited to this. For example, in the above first and fourth embodiments, the air blow unit 300 and the fixing unit 350 do not need to be provided.

In each of the above embodiments, a thermal print head or heads are used, but the print head or heads are not limited to these. For example, a piezoelectric print head or heads which eject ink droplets from ejection ports using shockwaves generated by piezoelectric elements may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to reduce a decrease in the throughput of a printing apparatus.

This application claims the benefit of Japanese Patent Application No. 2024-208416, filed Nov. 29, 2024, which is hereby incorporated by reference herein in its entirety.

What is claimed is:

1. A printing apparatus comprising:
a print head configured to eject a liquid onto a print medium to print an image;
a temperature detector provided to the print head and configured to detect a temperature; and
a controller configured to perform standby control which causes the print head to stand by for a standby time in a case where the temperature detected by the temperature detector is higher than a standby temperature, wherein
the controller determines whether to perform the standby control based on at least one of print information for printing an image onto the print medium with the print head or environmental temperature information on an environmental temperature.

2. The printing apparatus according to claim 1, wherein
the printing apparatus is capable of performing multipass printing in which the print head performs a plurality of printing scans over a predetermined region of the print medium to complete printing on the predetermined region,
the number of passes to be repeated in the multipass printing, an amount of the liquid to be applied to the print medium, and a scanning speed of the print head are set based on the print information, and
the controller determines to perform the standby control in a case where an average ejection frequency calculated based on the number of passes to be repeated, the amount of the liquid to be applied, and the scanning speed is higher than a predetermined reference frequency.

3. The printing apparatus according to claim 1, further comprising an air blow unit configured to heat a gas and send the gas onto a portion of the print medium facing the print head, wherein
a heating temperature for heating the gas with the air blow unit is set based on the print information, and
the controller determines to perform the standby control in a case where the heating temperature is higher than a predetermined reference heating temperature.

4. The printing apparatus according to claim 1, further comprising a fixing unit configured to fix the liquid ejected onto the print medium by the print head by drying the liquid, wherein
a fixing temperature for fixing the liquid with the fixing unit is set based on the print information, and
the controller determines to perform the standby control in a case where the fixing temperature is higher than a predetermined reference fixing temperature.

5. The printing apparatus according to claim 1, wherein the controller determines to perform the standby control in a case where the environmental temperature is higher than a predetermined reference environmental temperature.

6. The printing apparatus according to claim 1, wherein the controller determines whether to perform the standby control based on the print information, the environmental temperature information, and information on an amount of the liquid to be ejected by the print head.

7. The printing apparatus according to claim 1, further comprising a circulation pump for circulating the liquid to be supplied to the print head, wherein
the controller determines whether to perform the standby control based on the print information, the environmental temperature information, and information on a circulation flow rate of the liquid to be circulated by the circulation pump.

8. The printing apparatus according to claim 1, wherein
the print head has a printing element configured to generate a thermal energy for ejecting the liquid, and
the controller determines whether to perform the standby control based on the print information, the environmental temperature information, and information on a size of the printing element.

9. The printing apparatus according to claim 1, wherein
the printing apparatus is capable of performing multipass printing in which the print head performs a plurality of printing scans over a predetermined region of the print medium to complete printing on the predetermined region,
the number of passes to be repeated in the multipass printing, an amount of the liquid to be applied to the print medium, and a scanning speed of the print head are set based on the print information, and
the controller determines to perform the standby control in a case where an average ejection frequency calculated based on the number of passes to be repeated, the amount of the liquid to be applied, and the scanning speed is higher than a predetermined reference frequency, and determines not to perform the standby control in a case where the average ejection frequency is the predetermined reference frequency or lower.

10. The printing apparatus according to claim 1, further comprising an air blow unit configured to heat a gas and send the gas onto a portion of the print medium facing the print head, wherein
a heating temperature for heating the gas with the air blow unit is set based on the print information, and
the controller determines to perform the standby control in a case where the heating temperature is higher than a predetermined reference heating temperature, and determines not to perform the standby control in a case where the heating temperature is the predetermined reference heating temperature or lower.

11. The printing apparatus according to claim 1, further comprising a fixing unit configured to fix the liquid ejected onto the print medium by the print head by drying the liquid, wherein
a fixing temperature for fixing the liquid with the fixing unit is set based on the print information, and
the controller determines to perform the standby control in a case where the fixing temperature is higher than a predetermined reference fixing temperature, and determines not to perform the standby control in a case where the fixing temperature is the predetermined reference fixing temperature or lower.

12. The printing apparatus according to claim 1, wherein the controller determines to perform the standby control in a case where the environmental temperature is higher than a predetermined reference environmental temperature, and determines not to perform the standby control in a case where the environmental temperature is the predetermined reference environmental temperature or lower.

13. The printing apparatus according to claim 1, wherein
the printing apparatus comprises a plurality of the print heads,
the printing apparatus further comprises a carriage configured to carry the plurality of print heads, and
the controller determines whether to perform the standby control for each of the plurality of print heads.

14. The printing apparatus according to claim 1, wherein
the controller performs temperature lowering control which causes the print head to stand by until the temperature detected by the temperature detector becomes lower than a standby end temperature in a case where the temperature detected by the temperature detector is higher than a standby start temperature, and
the standby temperature and the standby end temperature are set to temperatures lower than the standby start temperature.

15. A method of controlling a printing apparatus including a print head configured to eject a liquid onto a print medium to print an image and a temperature detector provided to the print head and configured to detect a temperature, the method comprising:
performing standby control which causes the print head to stand by for a standby time in a case where the temperature detected by the temperature detector is higher than a standby temperature; and
determining whether to perform the standby control based on at least one of print information for printing an image onto the print medium with the print head or environmental temperature information on an environmental temperature.

16. A non-transitory computer readable storage medium storing a program for causing a computer to execute a method of controlling a printing apparatus including a print head configured to eject a liquid onto a print medium to print an image and a temperature detector provided to the print head and configured to detect a temperature, the method comprising:
performing standby control which causes the print head to stand by for a standby time in a case where the temperature detected by the temperature detector is higher than a standby temperature; and
determining whether to perform the standby control based on at least one of print information for printing an image onto the print medium with the print head or environmental temperature information on an environmental temperature.
